(19) United States
(12) Patent Application Publication
(10) Pub. No.: US 2017/0019265 A1
(43) Pub. Date: Jan. 19, 2017

(54) METHOD, TERMINAL AND SERVER FOR CONTROLLING SMART DEVICE

(71) Applicant: Xiaomi Inc., Beijing (CN)

(72) Inventors: Enxing Hou, Beijing (CN); Fan Zeng, Beijing (CN); Yangpeng Lv, Beijing (CN)

(21) Appl. No.: 15/060,618

(22) Filed: Mar. 4, 2016

(30) Foreign Application Priority Data
Jul. 13, 2015 (CN) 201510408993.0

(51) Int. Cl. H04L 12/28; H04B 5/00; H04L 29/06; H04W 8/24; H04W 12/06; H04W 12/08; H04W 4/00; H04L 29/08

(52) U.S. Cl. CPC H04L 12/2818; H04W 4/005; H04B 5/0062; H04L 67/26; H04W 4/008; H04W 8/24; H04W 12/06; H04W 12/08; H04L 63/123

(57) ABSTRACT

A method, terminal and server for controlling a smart home device are provided. The method includes: acquiring a device identification of the smart home device from the smart home device, and sending an enquiry request containing the device identification to a server; receiving an enquiry response from the server and pushing the enquiry response to a user; sending a control instruction to the server, the control instruction including a first trigger condition and a first execution condition selected by the user; controlling the smart home device to execute the first execution condition when the server detects that the first trigger condition is met.

### CROSS-REFERENCE TO RELATED APPLICATIONS

This application is based upon and claims priority to Chinese Patent Application No. 201510408993.0, filed on Jul. 13, 2015, the entire contents of which are incorporated herein by reference.

### TECHNICAL FIELD

The present disclosure generally relates to a field of smart home, and more particularly, to a method, terminal and server for controlling a smart home device.

### BACKGROUND

Smart home device control refers to a method for controlling the smart home device to perform corresponding actions when certain trigger condition is met, for example, a button is pressed by a user, or data detected by a smart sensor exceeds a threshold, etc.

With the solution of the smart home device control, various smart home devices, such as audio and video device, illumination system, curtain control, air-condition control, can be connected together to provide various functions and means, such as household electrical appliances control, illumination control, telephone remote control, indoor and outdoor remote control. Based on the solution of the smart home device control, a smart home may provide full information interaction function, and save money on various types of energy. Therefore, with wide application of smart home, smart home devices are popularizing and being applied rapidly.

### SUMMARY

The present disclosure provides a method for controlling a smart home device, a terminal and a server. Technical solutions are as follows.

According to a first aspect of embodiments of the present disclosure, there is provided a method implemented in a terminal for controlling a smart home device, the method including: acquiring a device identification of the smart home device from the smart home device, and sending an enquiry request containing the device identification to a server; receiving an enquiry response from the server and pushing the enquiry response to a user, the enquiry response including a group of trigger conditions and a group of execution conditions corresponding to the device identification; and sending a control instruction to the server, the control instruction including a first trigger condition and a first execution condition selected by the user from the group of trigger conditions and the group of execution conditions, the control instruction being configured to enable the server to control the smart home device to execute the first execution condition when the server detects that the first trigger condition is met.

According to a second aspect of embodiments of the present disclosure, there is provided a method implemented in a server for controlling a smart home device, the method including: receiving an enquiry request containing a device identification of the smart home device from a terminal, the device identification obtained from the smart home device by the terminal; sending an enquiry response to the terminal, the enquiry response including a group of trigger conditions and a group of execution conditions corresponding to the device identification; receiving a control instruction from the terminal, the control instruction including a first trigger condition and a first execution condition selected by a user from the group of trigger conditions and the group of execution conditions; and controlling the smart home device to execute the first execution condition, when detecting that the first trigger condition is met.

According to a third aspect of embodiments of the present disclosure, there is provided a terminal, including: a processor; and a memory for storing instructions executable by the processor; in which the processor is configured to perform: acquiring a device identification of the smart home device from the smart home device, and sending an enquiry request containing the device identification to a server; receiving an enquiry response from the server and pushing the enquiry response to a user, the enquiry response including a group of trigger conditions and a group of execution conditions corresponding to the device identification; send a control instruction to the server, the control instruction including a first trigger condition and a first execution condition selected by the user from the group of trigger conditions and the group of execution conditions, the control instruction being configured to enable the server to control the smart home device to execute the first execution condition when the server detects that the first trigger condition is met.

According to a fourth aspect of embodiments of the present disclosure, there is provided a server, including: a processor; and a memory for storing instructions executable by the processor; wherein the processor is configured to perform: receiving an enquiry request containing a device identification of the smart home device from a terminal, the device identification obtained from the smart home device by the terminal; sending an enquiry response to the terminal, the enquiry response including a group of trigger conditions and a group of execution conditions corresponding to the device identification; receiving a control instruction from the terminal, the control instruction including a first trigger condition and a first execution condition selected by a user from the group of trigger conditions and the group of execution conditions; controlling the smart home device to execute the first execution condition, when detecting that the first trigger condition is met.

The technical solutions provided by the present disclosure may include following advantages.

The user may obtain the device identification from the smart home device required to be controlled via the terminal. Moreover, the terminal obtains the group of trigger conditions and the group of execution conditions supported by the smart home device from the server according to the device identification. Then the user selects required trigger condition and execution condition from the group of trigger conditions and the group of execution conditions, and sends the required trigger condition and execution condition to the server via the terminal. And the server controls the smart home device according to the trigger condition and execution condition selected by the user. In the scenario of a large number of smart home devices, the user may identify the device identification of the smart home device required to be controlled conveniently and accurately via the terminal, so as to implement a smart home control in a convenient and accurate way.

Further, in one implementation according to embodiments of the present disclosure, based on a short-range communication or a two-dimension code scanning, the user may obtain the identification of the smart home device by using the terminal if the user is around the smart home device, which implements a control on the smart home device in a convenient and accurate way.

In another implementation according to embodiments of the present disclosure, the binding relationship between the user and the smart home device is established in advance. When receiving the enquiry request, the server sends feedback to the terminal only when the binding relationship between the smart home device required to be controlled and the user is determined, which effectively ensures security of smart home.

In yet another implementation according to embodiments of the present disclosure, the user may add a trigger condition set by oneself into the group of trigger conditions supported by the smart home device. In this way, it is possible to have the trigger condition of the smart home device made to order according to a user's requirement, thus improving personalization and flexibility of smart home.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flow chart showing a method for controlling a smart home device according to an exemplary embodiment.

FIG. 2A is a flow chart showing a method for controlling a smart home device according to another exemplary embodiment.

FIG. 2B is a flow chart showing a method for controlling a smart home device according to another exemplary embodiment.

FIG. 2C is a flow chart showing a method for controlling a smart home device according to another exemplary embodiment.

FIG. 2D is a flow chart showing a method for controlling a smart home device according to another exemplary embodiment.

FIG. 3 is a flow chart showing a method for controlling a smart home device according to another exemplary embodiment.

FIG. 4A is a flow chart showing a method for controlling a smart home device according to another exemplary embodiment.

FIG. 4B is a flow chart showing a method for controlling a smart home device according to another exemplary embodiment.

FIG. 5 is a flow chart showing a method for controlling a smart home device according to another exemplary embodiment.

FIG. 6 is a flow chart showing a method for controlling a smart home device according to another exemplary embodiment.

FIG. 7 is a flow chart showing a method for controlling a smart home device according to an exemplary embodiment.

FIG. 8A is a flow chart showing a method for controlling a smart home device according to another exemplary embodiment.

FIG. 8B is a flow chart showing a method for controlling a smart home device according to another exemplary embodiment.

FIG. 9 is a flow chart showing a method for controlling a smart home device according to another exemplary embodiment.

FIG. 10 is a flow chart showing a method for controlling a smart home device according to another exemplary embodiment.

FIG. 11 is a flow chart showing a method for controlling a smart home device according to an exemplary embodiment.

FIG. 12 is a block diagram illustrating a terminal according to an exemplary embodiment.

FIG. 13A is a block diagram illustrating a terminal according to another exemplary embodiment.

FIG. 13B is a block diagram illustrating a terminal according to another exemplary embodiment.

FIG. 13C is a block diagram illustrating a terminal according to another exemplary embodiment.

FIG. 13D is a block diagram illustrating a terminal according to another exemplary embodiment.

FIG. 14 is a block diagram illustrating a terminal according to another exemplary embodiment.

FIG. 15 is a block diagram illustrating a terminal according to another exemplary embodiment.

FIG. 16 is a block diagram illustrating a terminal according to another exemplary embodiment.

FIG. 17 is a block diagram illustrating a terminal according to another exemplary embodiment.

FIG. 18 is a block diagram illustrating a server according to an exemplary embodiment.

FIG. 19A is a block diagram illustrating a server according to another exemplary embodiment.

FIG. 19B is a block diagram illustrating a server according to another exemplary embodiment.

FIG. 20 is a block diagram illustrating a server according to another exemplary embodiment.

FIG. 21 is a block diagram illustrating a server according to another exemplary embodiment.

FIG. 22 is a block diagram of a terminal, according to an exemplary embodiment.

FIG. 23 is a block diagram of a server according to an exemplary embodiment.

FIG. 24 is a block diagram of a terminal 2400 according to an exemplary embodiment.

FIG. 25 is a block diagram of a server 2500 according to an exemplary embodiment.

The accompanying drawings, which are incorporated in and constitute a part of this specification, illustrate embodiments consistent with the invention and, together with the description, serve to explain the principles of the invention.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of devices and methods consistent with aspects related to the invention as recited in the appended claims.

First, some terms related to the embodiments of the present disclosure will be explained in the following.

“Terminal” includes but is not limited to an electronic device capable of operation during mobility, including but not limited to, any one of mobile electronic products, such as a mobile phone, a smart phone, a PAD (personal digital assistant), a laptop, a tablet computer, a POS (Point Of Sale), a vehicle-mounted computer, which may interact with a person via a keyboard, a touchpad or an acoustic control device. It should be understood by a person skilled in the art that other mobile terminals, if applicable to the present disclosure, also should be included in the protection scope of the present disclosure.

Smart home device includes but is not limited to a household electrical appliance formed by incorporating a microprocessor, a sensor technology and a network communication technology therein, which may automatically sense a residential space state, a state of the household electrical appliance itself and a service state of the household electrical appliance, and automatically control and receive in-house or remote control instructions to perform corresponding operations.

Server includes but is not limited to a data storage and computation entity connectioned with the terminal via network, including but not limited to, a general purpose computer, a specific computing device, a virtual computing device. A server may provide service for a plurality of terminals.

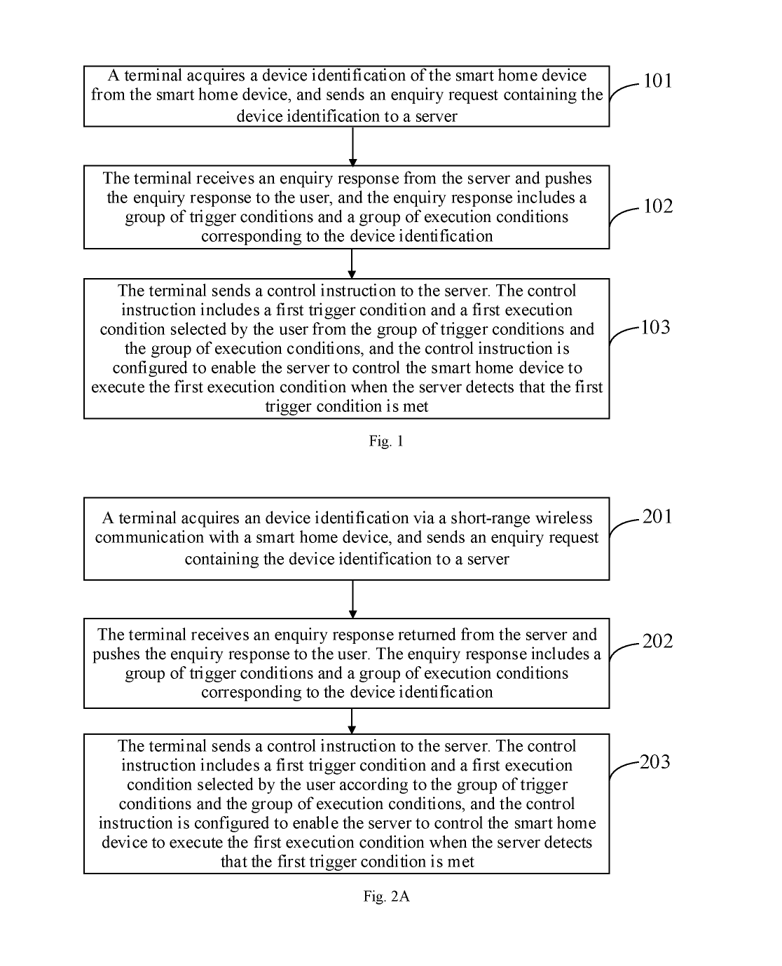

FIG. 1 is a flow chart showing a method for controlling a smart home device according to an exemplary embodiment. As shown in FIG. 1, this embodiment is exemplified by applying the method for controlling a smart home device in a terminal. The method for controlling a smart home device may include the following steps.

In step 101, a terminal acquires a device identification of the smart home device from the smart home device, and sends an enquiry request containing the device identification to a server.

The device identification is used for identifying the smart home device, for example, the device identification may be an MAC (Media Access Control) address of the smart home device.

A practical application scenario will be taken as an example for illustration. The scenario is related to a smart home, which may include a large number of smart home devices.

In the smart home, control information of various smart home devices may be configured in the server in advance. The control information includes a trigger condition and an execution condition. Accordingly, if the server detects that the trigger condition is met, for example, the trigger condition may be press of a button by a user and detection of certain data exceeding a predetermined threshold by a smart sensor, or if it is detected that working state of other smart home device meets a predetermined state, then the server controls a corresponding smart home device to execute the execution condition, for example, switching on or off, thereby implementing a smart home control solution and effectively promoting user experience.

Specifically, in the smart home control solution, the control information of the smart home device needs to be configured in advance, that is, the server needs to acquire the trigger condition and the execution condition of the smart home device in advance. In this embodiment, the terminal acquires the device identification of the smart home device from the smart home device conveniently, and sends the enquiry request containing the device identification to the server to execute subsequent solution.

In step 102, the terminal receives an enquiry response from the server and pushes the enquiry response to the user. The enquiry response includes a group of trigger conditions and a group of execution conditions corresponding to the device identification.

Again, the practical application scenario described above is taken as an example.

After the terminal sends the enquiry request to the server, according to the device identification in the enquiry request, the server inquires groups of trigger conditions and execution condition groups corresponding to device identifications of respective smart home devices to obtain the group of trigger conditions and the group of execution conditions corresponding to the device identification, i.e., a group of trigger conditions and a group of execution conditions supported by the smart home device. The server returns the enquiry response including the group of trigger conditions and the group of execution conditions supported by the smart home device to the terminal. After receiving the enquiry response, the terminal pushes the group of trigger conditions and the group of execution conditions supported by the smart home device to the user to execute subsequent solution.

Herein, the group of trigger conditions is a group of trigger conditions which includes at least one trigger condition, and the group of execution conditions is a group of the execution conditions which includes at least one the execution condition.

Specifically, the group of execution conditions supported by the smart home device may be decided by features of the smart home device. For example, for a smart illumination device, the group of execution conditions supported thereby may include switching on illumination and switching off illumination.

Still further specifically, the group of trigger conditions supported by the smart home device may be predetermined or may be determined according to the user's requirement. Again, for the smart illumination device, the group of trigger conditions supported by it may include one press of a button or two successive presses of the button by the user.

In step 103, the terminal sends a control instruction to the server. The control instruction includes a first trigger condition and a first execution condition selected by the user from the group of trigger conditions and the group of execution conditions, and the control instruction is configured to enable the server to control the smart home device to execute the first execution condition when the server detects that the first trigger condition is met.

Again, the practical application scene described above is taken as an example.

After the terminal pushes the group of trigger conditions and the group of execution conditions supported by the smart home device to the user, the user may select the first trigger condition and the first execution condition therefrom. The terminal encapsulates the first trigger condition and the first execution condition selected by the user into the control instruction and sends the control instruction to the server. According to the control instruction, the server controls the smart home device to execute the first execution condition when detecting that the first trigger condition is met, thus the smart home is realized.

Again, the smart illumination device described above is taken as an example. Suppose that the first trigger condition selected by the user is to press the button twice successively by the user, and the first execution condition is switching on, when detecting that the button is pressed twice successively by the user, the server may send a corresponding instruction to the smart illumination device to control switching on of the smart illumination device, thus achieving smart control of the smart illumination device.

In this embodiment, when wishing to control certain smart home device, the user may directly obtain the device identification of the smart home device from the smart home device via the terminal, the terminal obtains the group of trigger conditions and the group of execution conditions supported by the smart home device for the user to select by sending the enquiry request to the server, and the user sends the first trigger condition and the first execution condition selected to the server via the terminal, thus achieving smart control of the smart home device.

In practice, in a scenario including a large number of smart home devices, a solution that the user identifies the device identification of the smart home device that the user wants to control from a list of device identifications of a large number of smart home devices, not only has low efficiency, but also easily makes identification error.

However, according to the solution of the present embodiment, in a scenario of a large number of smart home devices, it is not required for the user to manually identify the device identification of the smart home device that the user wants to control from the list of device identifications of a large number of smart home devices, instead, the user may acquire a corresponding device identification conveniently and accurately from the smart home device that the user wants to control, which improves convenience and reliability of the smart home device control. Moreover, according to the solution of the present embodiment, the groups of trigger conditions and the groups of execution conditions supported by various smart home devices may be stored in the server, which further effectively saves storage resource of the terminal.

The methods related to a server in this embodiment may be referred to related contents of following embodiments, which will not be described herein.

In conclusion, according to the method for controlling a smart home device according to the embodiment of the present disclosure, the user may obtain the device identification from the smart home device required to be controlled via the terminal. Moreover, the terminal obtains the group of trigger conditions and the group of execution conditions supported by the smart home device from the server according to the device identification. Then the user selects required trigger condition and execution condition from the group of trigger conditions and the group of execution conditions, and sends the required trigger condition and execution condition to the server via the terminal. And the server controls the smart home device according to the trigger condition and execution condition selected by the user. In the scenario of a large number of smart home devices, the user may identify the device identification of the smart home device required to be controlled conveniently and accurately via the terminal, so as to implement a smart home control in a convenient and accurate way.

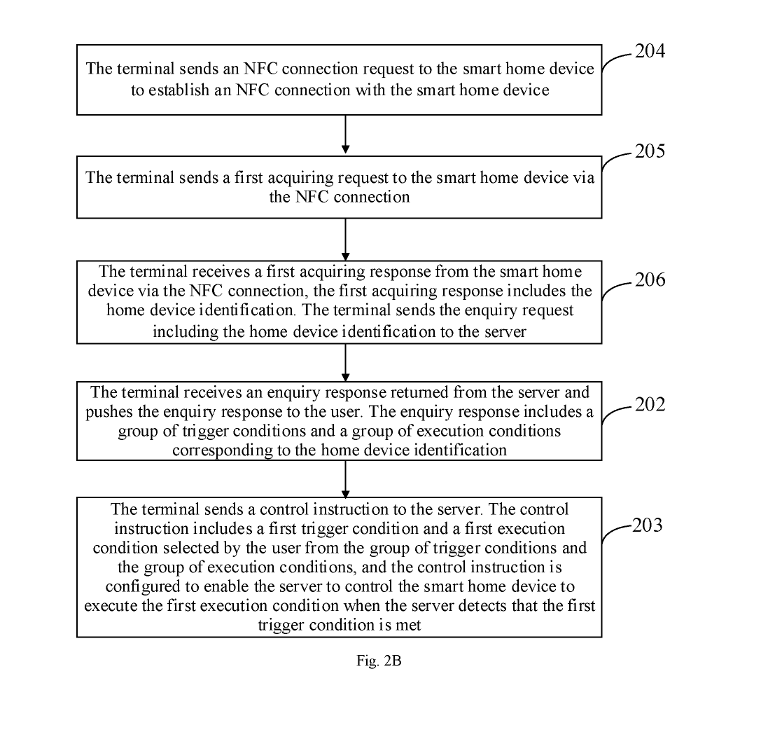

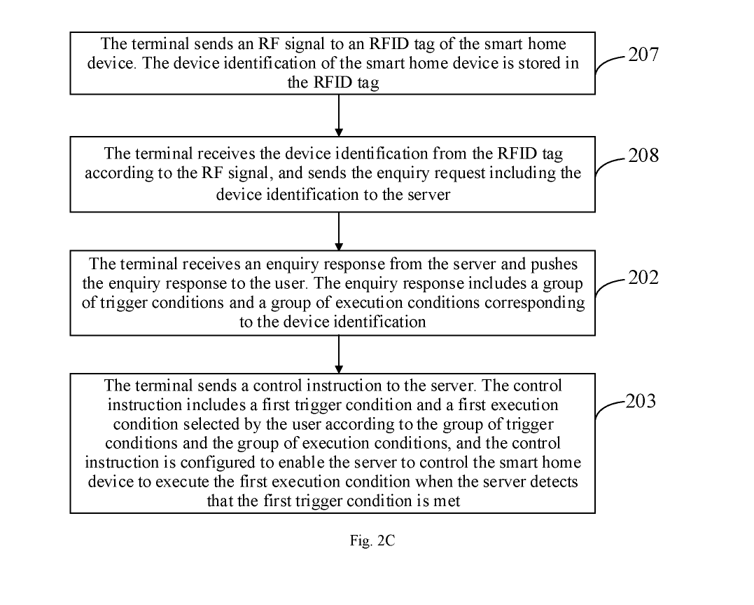

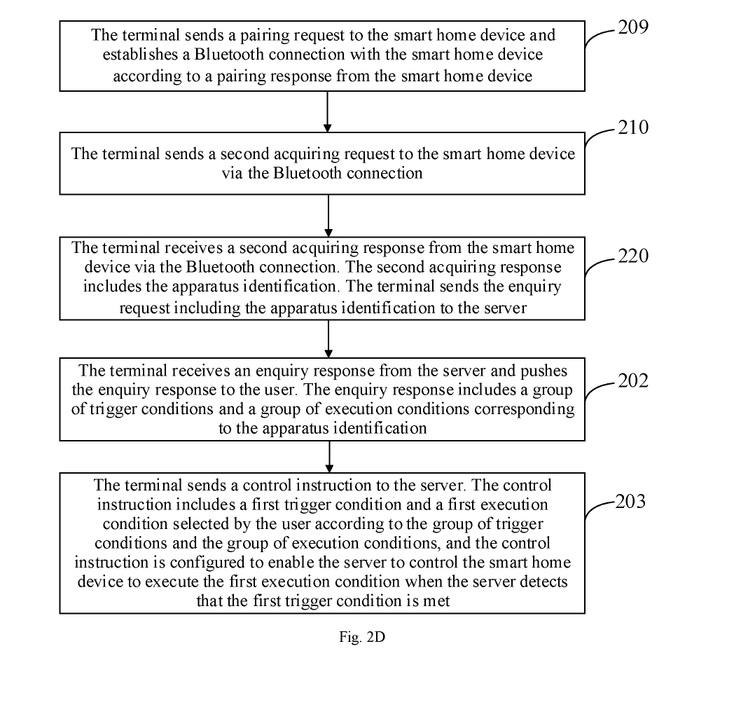

FIG. 2A is a flow chart showing a method for controlling a smart home device, according to another exemplary embodiment. As shown in FIG. 2A, the method for controlling a smart home device applied in a terminal is taken as an example for illustration in this embodiment. The method for controlling a smart home device may include the following steps.

In step 201, a terminal acquires a device identification via near field wireless communication with a smart home device, and sends an enquiry request containing the device identification to a server.

In step 202, the terminal receives an enquiry response from the server and pushes the enquiry response to the user. The enquiry response includes a group of trigger conditions and a group of execution conditions corresponding to the device identification.

In step 203, the terminal sends a control instruction to the server. The control instruction includes a first trigger condition and a first execution condition selected by the user from the group of trigger conditions and the group of execution conditions, and the control instruction is configured to enable the server to control the smart home device to execute the first execution condition when the server detects that the first trigger condition is met.

The short-range wireless communication between the terminal and the smart home device may include many manners.

Alternatively, an NFC (Near Field Communication) may be applied to realize the short-range wireless communication. Accordingly, FIG. 2B shows a flow chart of a method for controlling a smart home device according to another exemplary embodiment. On the basis of the embodiment shown in FIG. 2A, step 201 may include following steps specifically.

In step 204, the terminal sends an NFC connection request to the smart home device to establish an NFC connection with the smart home device.

In step 205, the terminal sends a first acquiring request to the smart home device via the NFC connection.

In step 206, the terminal receives a first acquiring response from the smart home device via the NFC connection. The first acquiring response includes the device identification. The terminal sends the enquiry request including the device identification to the server.

In practice, an NFC tag may be disposed on the smart home device. When a terminal equipped with an NFC chip gets close to the NFC tag of the smart home device, the NFC chip sends the NFC connection request to the NFC tag. In this way, an NFC connection between the terminal and the smart home device may be established, and thus a data communication therebetween is realized based on the NFC connection. Specifically, the NFC chip of the terminal sends the acquiring request to the NFC tag of the smart home device via the NFC connection, and the smart home device sends the device identification stored in itself to the NFC chip of the terminal via the NFC tag according to the acquiring request, thus enabling the terminal to acquire the device identification of the smart home device in a convenient and accurate way.

Still further alternatively, an RFID (Radio Frequency Identification) may be applied to realize the short-range wireless communication. Accordingly, as shown in FIG. 2C, FIG. 2C is a flow chart showing a method for controlling a smart home device, according to another exemplary embodiment. Based on the embodiment shown in FIG. 2A, specifically, step 201 may include the following steps.

In step 207, the terminal sends an RF signal to an RFID tag of the smart home device. The device identification of the smart home device is stored in the RFID tag.

In step 208, the terminal receives the device identification from the RFID tag according to the RF signal, and sends the enquiry request including the device identification to the server.

In practice, the RFID tag may be disposed on the smart home device. When the terminal gets close to the RFID tag of the smart home device, the terminal sends the RF signal to the RFID tag, the RFID tag of the smart home device sends the device identification stored in itself to the terminal in response to the RF signal, thereby enabling the terminal to acquire the device identification of the smart home device in a convenient and accurate way.

Still further alternatively, a Bluetooth may be applied to realize the short-range wireless communication. Accordingly, as shown in FIG. 2D, FIG. 2D is a flow chart showing a method for controlling a smart home device, according to another exemplary embodiment. Based on the embodiment shown in FIG. 2A, step 201 may include following steps specifically.

In step 209, the terminal sends a pairing request to the smart home device and establishes a Bluetooth connection with the smart home device according to a pairing response from the smart home device.

In step 210, the terminal sends a second acquiring request to the smart home device via the Bluetooth connection.

In step 220, the terminal receives a second acquiring response from the smart home device via the Bluetooth connection. The second acquiring response includes the device identification. The terminal sends the enquiry request including the device identification to the server.

In practice, a Bluetooth module may be disposed on the smart home device. When a terminal supporting Bluetooth gets close to the smart home device, the terminal sends the pairing request to the smart home device. In this way, a Bluetooth connection between the terminal and the smart home device may be established according to the pairing response from the smart home device, and thus a data communication therebetween is realized based on the Bluetooth connection. Specifically, the terminal sends the acquiring request to the smart home device via the Bluetooth connection, and the smart home device sends the device identification stored in itself to the terminal via the Bluetooth connection according to the acquiring request, thus enabling the terminal to acquire the device identification of the smart home device in a convenient and accurate way.

The methods related to a server in this embodiment may be referred to related contents of the following embodiments, which will not be described herein.

In conclusion, according to the method for controlling a smart home device according to the embodiment of the present disclosure, through short-range wireless communication manner, the user may determine the device identification of the smart home device that the user wants to control using a terminal. In other words, the user may obtain the device identification of the smart home device only by staying around the smart home device, which achieves controlling of the smart home device in a convenient and accurate way.

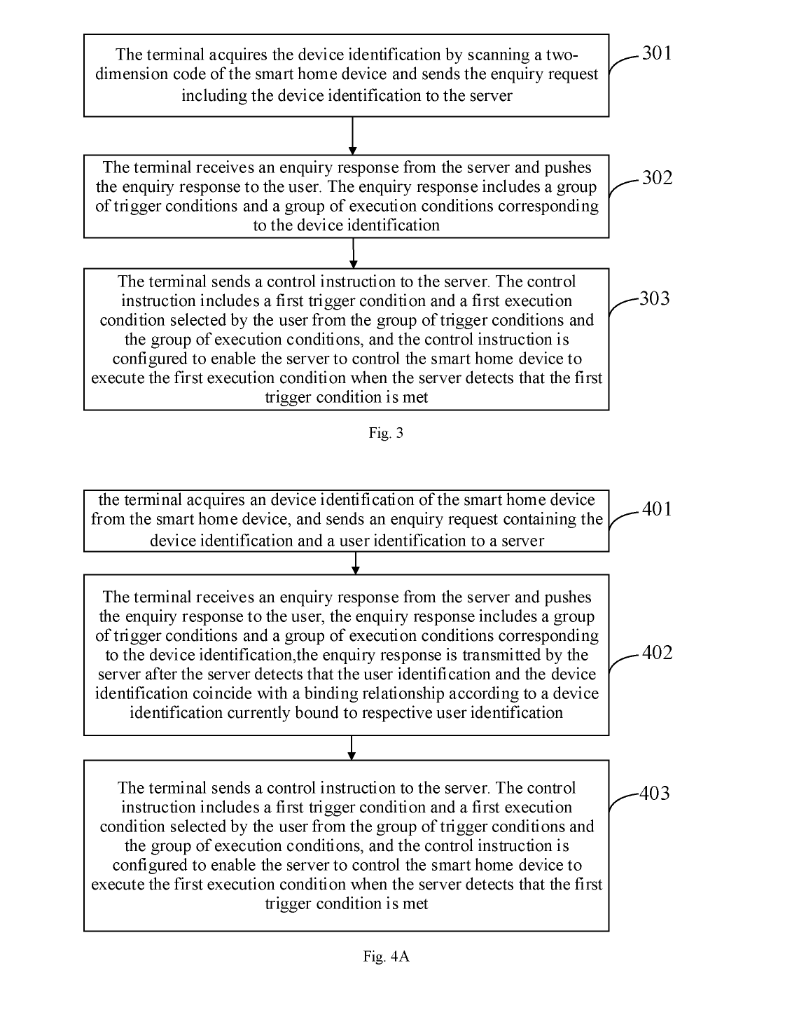

FIG. 3 is a flow chart showing a method for controlling a smart home device according to another exemplary embodiment. As shown in FIG. 3, the method for controlling a smart home device applied in a terminal is taken as an example for illustration in this embodiment. The method for controlling a smart home device may include the following steps.

In step 301, the terminal acquires the device identification by scanning a two-dimension code of the smart home device and sends the enquiry request including the device identification to the server.

In step 302, the terminal receives an enquiry response from the server and pushes the enquiry response to the user. The enquiry response includes a group of trigger conditions and a group of execution conditions corresponding to the device identification.

In step 303, the terminal sends a control instruction to the server. The control instruction includes a first trigger condition and a first execution condition selected by the user according to the group of trigger conditions and the group of execution conditions, and the control instruction is configured to enable the server to control the smart home device to execute the first execution condition when the server detects that the first trigger condition is met.

In practice, the device identification of the smart home device may be encoded into a two-dimension code, and the two-dimension code is disposed on the smart home device. Accordingly, the user may simply use the terminal to scan the two-dimension code of the smart home device to read the device identification of the smart home device.

The method for a server involved in this embodiment may refer to related contents in following embodiments, which will not be described herein.

In conclusion, according to the method for controlling a smart home device according to the embodiment of the present disclosure, by using the terminal to scan the two-dimension code of the smart home device, the user may obtain the device identification of the smart home device, so as to implement a control for the smart home device in a convenient and accurate way.

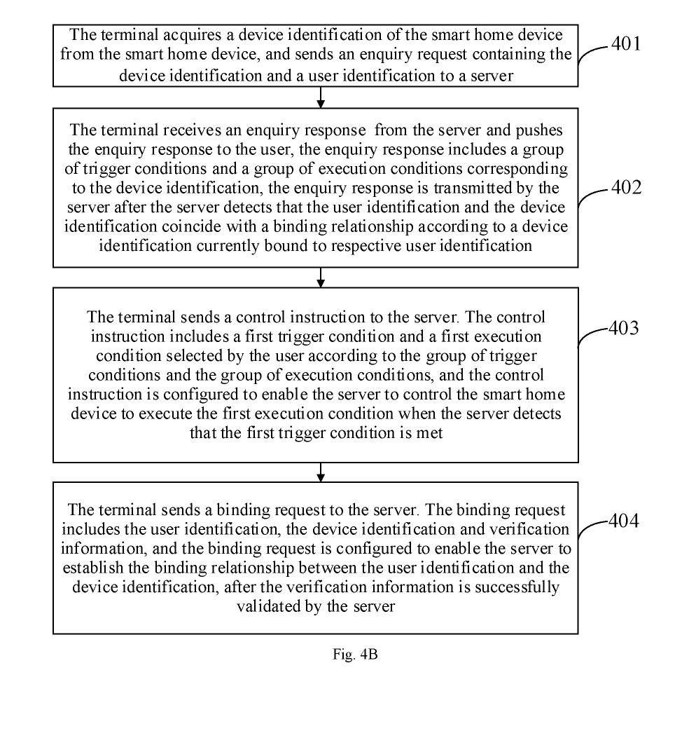

FIG. 4A is a flow chart showing a method for controlling a smart home device, according to another exemplary embodiment. As shown in FIG. 4A, the method for controlling a smart home device applied in a terminal is taken as an example for illustration in this embodiment. The method for controlling a smart home device may include the following steps.

In step 401, a terminal acquires a device identification of the smart home device from the smart home device, and sends an enquiry request containing the device identification and a user identification to a server.

In step 402, the terminal receives an enquiry response from the server and pushes the enquiry response to the user. The enquiry response includes a group of trigger conditions and a group of execution conditions corresponding to the device identification. The enquiry response is transmitted by the server when the server detects that the user identification and the device identification have a binding relationship according to device identifications currently bound to respective user identifications.

In step 403, the terminal sends a control instruction to the server. The control instruction includes a first trigger condition and a first execution condition selected by the user from the group of trigger conditions and the group of execution conditions, and the control instruction is configured to enable the server to control the smart home device to execute the first execution condition when the server detects that the first trigger condition is met.

The user identification refers to an identification characterizing an identity of the user, such as an ID number of the user or a user name of the user. Specifically, the terminal may directly acquire a pre-stored user identification, or may receive the user identification inputted by the user via an interactive interface.

Take a practical scenario for example. After acquiring the device identification of the smart home device from the smart home device, the terminal sends an enquiry request containing the device identification and the user identification to the server. The server inquires device identifications currently bound to respective user identifications according to the enquiry request received. The binding relationship between the user identification and the device identification mentioned herein is used for characterizing an ownership relation between the smart home device and the user. When determining that the device identification belongs to one of device identifications currently bound to the user identification, the server returns the enquiry response to the terminal.

In order to establish the binding relationship between respective user identifications and respective device identifications in the server, FIG. 4B illustrates a flow chart of a method for controlling a smart home device according to another exemplary embodiment. On the basis of the embodiment shown in FIG. 4A, the method for controlling a smart home device may include following steps.

In step 404, the terminal sends a binding request to the server. The binding request includes a user identification, a device identification and verification information. The binding request is used to enable the server to establish the binding relationship between the user identification and the device identification after successful validation of the verification information.

In practice, the verification information is used for proving the ownership between the user and the smart home device. Take a practical scenario for example. Each smart home device is configured with unique verification information in the factory, such as a validation code consisting of a series of numbers or letters, which is stored in the server. After purchasing the smart home device, a user may obtain the verification information corresponding to the smart home device. Accordingly, the user sends the binding request to the server via the terminal, and the binding request includes the device identification of the smart home device, the user identification of the user, and the verification information corresponding to the smart home device. The server validates the verification information of the smart home device according to the verification information of respective smart home devices currently stored. If the validation succeeds, it is determined that the smart home device belongs to the user, and then the server establishes the binding relationship between the user identification and the device identification.

It should be noted that, this embodiment may be implemented in combination with any one of embodiments shown in FIGS. 1-3. Specifically, for example, based on any one of the methods described in the above embodiments, the terminal may acquire the device identification of the smart home device, and sends the enquiry request containing the device identification and the user identification to the server. The server validates the ownership between the user and the smart home device according to the enquiry request. If the verification succeeds, the server returns the enquiry response to the terminal.

The method for a server involved in this embodiment may refer to related contents in following embodiments, which will not be described herein.

In conclusion, according to the method for controlling a smart home device according to the embodiment of the present disclosure, the ownership relation between the smart home device and the user is validated according to the verification information in the binding request, and the binding relationship between the user and the smart home device is established upon successful validation. After receiving the enquiry request from the terminal and determining that the smart home device to be controlled belongs to the user base on the binding relationship between respective user identifications and respective device identifications, the server then executes subsequent schemes of smart home device controlling, thereby improving security of smart home.

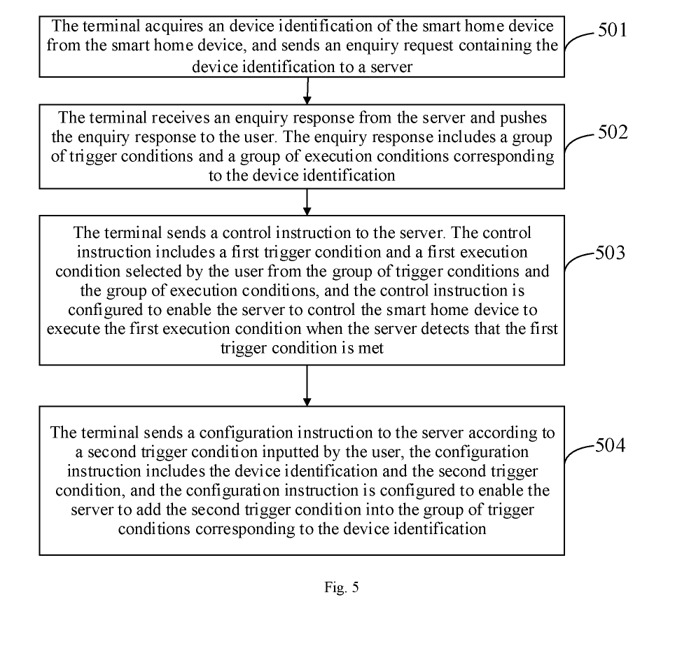

FIG. 5 is a flow chart showing a method for controlling a smart home device according to another exemplary embodiment. As shown in FIG. 5, this embodiment is exemplified by applying the method for controlling a smart home device in a terminal. The method for controlling a smart home device may include the following steps.

In step 501, a terminal acquires a device identification of the smart home device from the smart home device, and sends an enquiry request containing the device identification to a server.

In step 502, the terminal receives an enquiry response from the server and pushes the enquiry response to the user. The enquiry response includes a group of trigger conditions and a group of execution conditions corresponding to the device identification.

In step 503, the terminal sends a control instruction to the server. The control instruction includes a first trigger condition and a first execution condition selected by the user from the group of trigger conditions and the group of execution conditions, and the control instruction is configured to enable the server to control the smart home device to execute the first execution condition when the server detects that the first trigger condition is met.

In step 504, the terminal sends a configuration instruction to the server according to a second trigger condition inputted by the user. The configuration instruction includes the device identification and the second trigger condition, and the configuration instruction is used to enable the server to add the second trigger condition into the group of trigger conditions corresponding to the device identification.

Step 504 may be executed at any time after step 501 in which the terminal acquires the device identification of the smart home device from the smart home device, which is not restricted in the embodiment.

Take a practical scenario for example. If the user wants to set the trigger condition for certain smart home device, the user may use the terminal to acquire the device identification of the smart home device, and input the second trigger condition via an interactive interface of the terminal. The terminal sends the configuration instruction including the device identification and the second trigger condition set by the user to the server, and the server adds the second trigger condition set by the user into the group of trigger conditions supported by the smart home device according to the configuration instruction.

It should be noted that, this embodiment may be implemented in combination with any one of embodiments shown in FIGS. 1-4. Specifically, for example, based on any one of the methods described in the above embodiments, the terminal may acquire the device identification of the smart home device, and sends the configuration instruction including the device identification and the second trigger condition to the server, and the server updates the group of trigger conditions supported by the smart home device according to the configuration instruction.

The method for the server involved in this embodiment may refer to related contents in following embodiments, which will not be described herein.

In conclusion, according to the method for controlling a smart home device according to the embodiment of the present disclosure, the terminal sends the configuration instruction including the device identification of the smart home device and the second trigger condition set by the user to the server, and the server adds the second trigger condition set by the user into the group of trigger conditions supported by the smart home device according to the configuration instruction, thereby configuring the group of trigger conditions supported by the smart home device according to a user's requirement, and realizing personalization and flexibility of smart home.

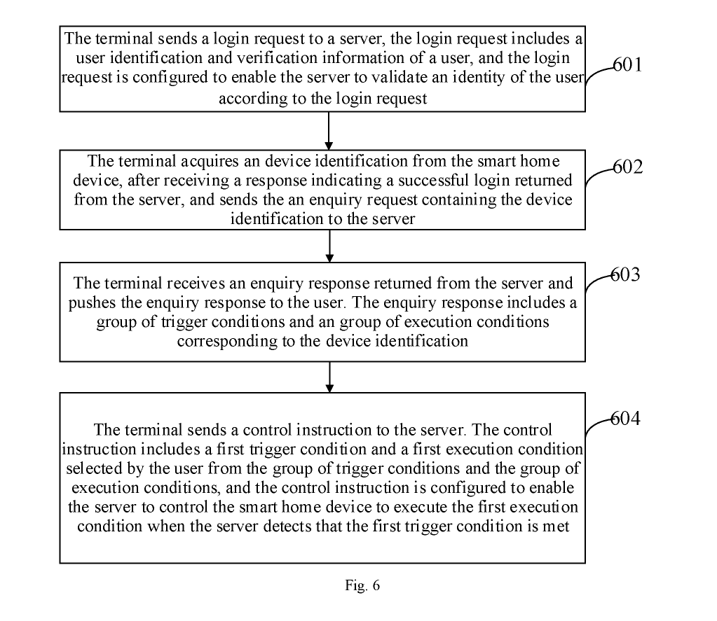

FIG. 6 is a flow chart showing a method for controlling a smart home device, according to another exemplary embodiment. As shown in FIG. 6, this embodiment is exemplified by applying the method for controlling a smart home device in a terminal. The method for controlling a smart home device may include the following steps.

In step 601, the terminal sends a login request to a server. The login request includes a user identification and verification information of a user, and the login request is used to enable the server to validate an identity of the user according to the login request.

In step 602, the terminal acquires a device identification from the smart home device after receiving a response indicating a successful login from the server, and sends the an enquiry request containing the device identification to the server.

In step 603, the terminal receives an enquiry response from the server and pushes the enquiry response to the user. The enquiry response includes a group of trigger conditions and a group of execution conditions corresponding to the device identification.

In step 604, the terminal sends a control instruction to the server. The control instruction includes a first trigger condition and a first execution condition selected by the user according to the group of trigger conditions and the group of execution conditions, and the control instruction is used to enable the server to control the smart home device to execute the first execution condition when the server detects that the first trigger condition is met.

Take a practical scenario for example. Before acquiring the device identification, the user sends the login request to the server via the terminal. The login request is used to enable the server to validate the identity of the user according to the login request. Specifically, the login request may include the user identification and the verification information. The user identification may be identical with that of the above embodiments, and the verification information may be a login password set by the user during registration. The server validates the identity of the user according to the login request, and returns the response indicating the success of the login to the terminal after the validation succeeds. After receiving the response indicating the success of the login, the terminal acquires the device identification from the smart home device and executes subsequent steps in the method for controlling a smart home device.

It should be noted that, this embodiment may be implemented in combination with any one of embodiments shown in FIGS. 1-5. Specifically, for example, the terminal sends the login request for validating the identity of the user to the server, after the login succeeds, based on any one of methods described above, the terminal may acquire the device identification of the smart home device and executes subsequent steps in the method for controlling a smart home device.

The method for the server involved in this embodiment may refer to related contents in following embodiments, which will not be described herein.

In conclusion, according to the method for controlling a smart home device according to the embodiment of the present disclosure, the terminal sends the login request including the user identification and the verification information to the server, the server validates the identity of the user according to the login request, and after the login succeeds, the terminal executes subsequent steps in the method for controlling a smart home device. By validating the identity of the user before controlling the smart home device, thereby security of smart home is further increased.

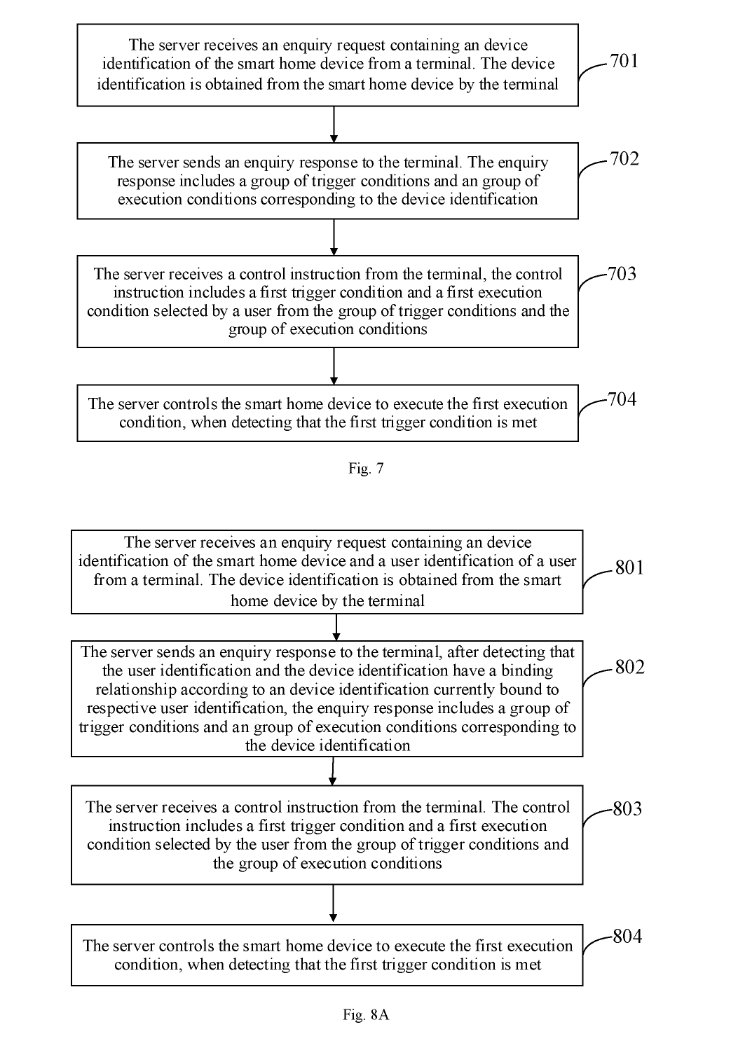

FIG. 7 is a flow chart showing a method for controlling a smart home device, according to an exemplary embodiment. As shown in FIG. 7, this embodiment is exemplified by applying the method for controlling a smart home device in a server. The method for controlling a smart home device may include the following steps.

In step 701, the server receives an enquiry request containing a device identification of the smart home device from a terminal. The device identification is obtained from the smart home device by the terminal.

In step 702, the server sends an enquiry response to the terminal. The enquiry response includes a group of trigger conditions and a group of execution conditions corresponding to the device identification.

In step 703, the server receives a control instruction from the terminal. The control instruction includes a first trigger condition and a first execution condition selected by a user from the group of trigger conditions and the group of execution conditions.

In step 704, the server controls the smart home device to execute the first execution condition, when detecting that the first trigger condition is met.

The device identification is for characterizing the smart home device, for example, the device identification may be an MAC (Media Access Control) address for the smart home device. The number of trigger conditions in the group of trigger conditions or the number of or the execution conditions in the group of execution conditions may be at least one.

Take a practical application scenario for example. The scenario relates to a smart home which may include a large number of smart home devices.

The terminal acquires the device identification of the smart home device from the smart home device, and sends the enquiry request containing the device identification to the server, the server searches group of trigger conditions and execution condition groups corresponding to device identifications of respective smart home devices for the group of trigger conditions and the group of execution conditions corresponding to the device identification, i.e., a group of trigger conditions and a group of execution conditions supported by the smart home device, and returns them to the terminal. After receiving the enquiry response, the terminal pushes the group of trigger conditions and the group of execution conditions supported by the smart home device to the user, and the user may select the first trigger condition and the first execution condition to be configured from the group of trigger conditions and the group of execution conditions supported by the smart home device. The terminal encloses the first trigger condition and the first execution condition selected by the user into the control instruction and sends the control instruction to the server. According to the control instruction, the server controls the smart home device to execute the first execution condition, thus implementing smart home, when detecting that the first trigger condition is met.

Specifically, the group of execution conditions supported by the smart home device may be determined on features of the device itself, and the group of trigger conditions supported by the smart home device may be predetermined or may be determined according to the user's requirement.

In this embodiment, when wishing to control certain smart home device, the user may directly obtain the device identification of the smart home device from the smart home device via the terminal, the terminal obtains the group of trigger conditions and the group of execution conditions supported by the smart home device for the user to select by sending the enquiry request to the server, and the user sends the first trigger condition and the first execution condition selected to the server via the terminal, thus implementing the smart control for the smart home device.

According to the solution based on the present embodiment, in the scenario of a large number of smart home devices, it is not required for the user to manually identify the device identification of the smart home device that the user wants to control from a list of device identifications of a large number of smart home devices, instead, the user may acquire a corresponding device identification conveniently and accurately from the smart home device that the user wants to control, which improves convenience and reliability of the smart home device control. Moreover, according to the solution of the present embodiment, the group of trigger conditions and the group of execution conditions supported by various smart home devices may be stored in the server, which further effectively saves a storage resource of the terminal.

The terminal may acquire the device identification from the smart home device via various manners, which may be referred to the embodiments above. The method for the terminal involved in this embodiment may refer to related contents in above embodiments, which will not be described herein.

FIG. 8A is a flow chart showing a method for controlling a smart home device, according to another exemplary embodiment. As shown in FIG. 8A, this embodiment is exemplified by applying the method for controlling a smart home device in a server. The method for controlling a smart home device may include the following steps.

In step 801, the server receives an enquiry request containing a device identification of the smart home device and a user identification of a user from a terminal. The device identification is obtained from the smart home device by the terminal.

In step 802, the server sends an enquiry response to the terminal, after detecting that the user identification and the device identification have a binding relationship according to device identifications currently bound to respective user identifications. The enquiry response includes a group of trigger conditions and a group of execution conditions corresponding to the device identification.

In step 803, the server receives a control instruction from the terminal. The control instruction includes a first trigger condition and a first execution condition selected by the user from the group of trigger conditions and the group of execution conditions.

In step 804, the server controls the smart home device to execute the first execution condition, when detecting that the first trigger condition is met.

The user identification refers to an identification characterizing an identity of the user, such as an ID number of the user or a user name of the user. Specifically, the terminal may directly acquire a pre-stored user identification, or may receive the user identification inputted by the user via an interactive interface.

Take a practical scene for example. After acquiring the device identification of the smart home device from the smart home device, the terminal sends an enquiry request containing the device identification and the user identification to the server. The server inquires device identifications currently bound to respective user identifications according to the enquiry request received. The binding relationship between the user identification and the device identification mentioned herein is used for characterizing an ownership relation between the smart home device and the user. When determining that the device identification belongs to one of device identifications currently bound to the user identification, the server returns the enquiry response to the terminal.

In order to establish the binding relationship between respective user identifications and respective device identifications in the server, FIG. 8B illustrates a flow chart of a method for controlling a smart home device, according to another exemplary embodiment. On the basis of the embodiment shown in FIG. 8A, the method for controlling a smart home device may include following steps.

In step 805, the server receives a binding request from the terminal. The binding request includes a user identification, a device identification and verification information.

In step 806, the server establishes the binding relationship between the user identification and the device identification, after successful validation of the verification information.

In practice, the verification information is used for validating the ownership between the user and the smart home device.

It should be noted that, this embodiment may be implemented in combination with the embodiment shown in FIG. 7. Specifically, for example, based on any one of the methods described in the above embodiments, the terminal may acquire the device identification of the smart home device, and sends the enquiry request containing the device identification and the user identification to the server. The server validates the ownership between the user and the smart home device according to the enquiry request. If the validation succeeds, the server returns the enquiry response to the terminal.

The method for the terminal involved in this embodiment may refer to related contents in above embodiments, which will not be described herein.

In conclusion, according to the method for controlling a smart home device according to the embodiment of the present disclosure, the ownership between the smart home device and the user is validated according to the verification information in the binding request, and the binding relationship between the user and the smart home device is established upon successful validation. After receiving the enquiry request from the terminal and determining that the smart home device to be controlled belongs to the user base on the binding relationship between respective user identifications and respective device identifications, the server then executes following subsequent schemes of smart home device controlling, thereby improving security of smart home.

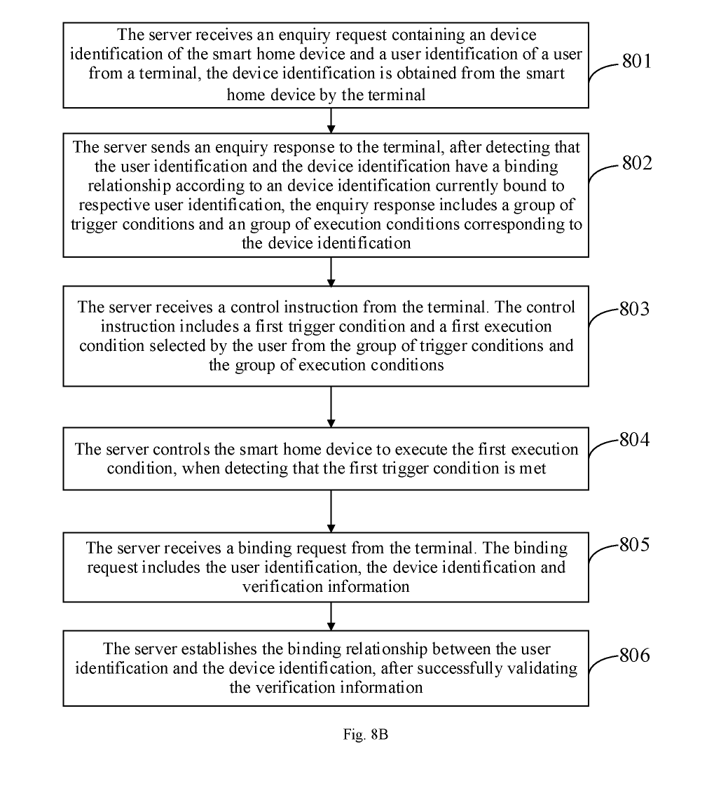

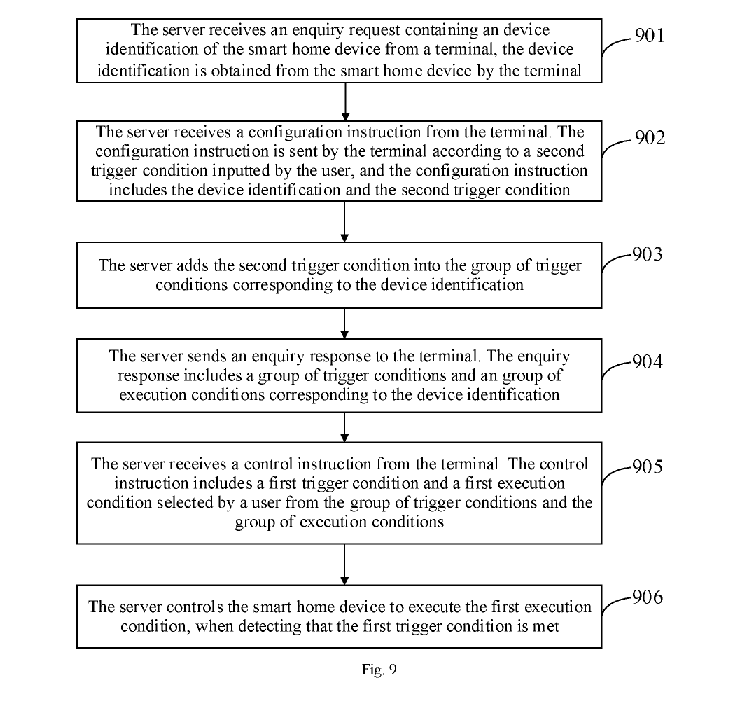

FIG. 9 is a flow chart showing a method for controlling a smart home device according to another exemplary embodiment. As shown in FIG. 9, this embodiment is exemplified by applying the method for controlling a smart home device in a server. The method for controlling a smart home device may include the following steps.

In step 901, the server receives an enquiry request containing a device identification of the smart home device from a terminal. The device identification is obtained from the smart home device by the terminal.

In step 902, the server receives a configuration instruction from the terminal. The configuration instruction is sent by the terminal according to a second trigger condition inputted by the user, and the configuration instruction includes the device identification and the second trigger condition.

In step 903, the server adds the second trigger condition into the group of trigger conditions corresponding to the device identification.

In step 904, the server sends an enquiry response to the terminal. The enquiry response includes a group of trigger conditions and a group of execution conditions corresponding to the device identification.

In step 905, the server receives a control instruction from the terminal. The control instruction includes a first trigger condition and a first execution condition selected by a user from the group of trigger conditions and the group of execution conditions.

In step 906, the server controls the smart home device to execute the first execution condition, when detecting that the first trigger condition is met.

Step 902 and step 903 may be executed at any time after the terminal acquires the device identification of the smart home device from the smart home device, which is not restricted in the embodiment.

Take a practical scenario for example. If the user wants to set the trigger condition for certain smart home device, the user may use the terminal to acquire the device identification of the smart home device, and input the second trigger condition via an interactive interface of the terminal. The terminal sends the configuration instruction including the device identification and the second trigger condition set by the user to the server, and the server adds the second trigger condition set by the user into the group of trigger conditions supported by the smart home device according to the configuration instruction.

It should be noted that, this embodiment may be implemented in combination with any one of embodiments as shown in FIG. 7, FIG. 8A and FIG. 8B. Specifically, for example, the terminal may acquire the device identification of the smart home device, and sends the configuration instruction including the device identification and the second trigger condition to the server, and the server updates the group of trigger conditions supported by the smart home device according to the configuration instruction.

The method for the terminal involved in this embodiment may refer to related contents in above embodiments, which will not be described herein.

In conclusion, according to the method for controlling a smart home device according to the embodiment of the present disclosure, the terminal sends the configuration instruction including the device identification of the smart home device and the second trigger condition set by the user to the server, and the server adds the second trigger condition set by the user into the group of trigger conditions supported by the smart home device according to the configuration instruction, thus configuring the group of trigger conditions supported by the smart home device according to a user's requirement, and realizing personalization and flexibility of smart home.

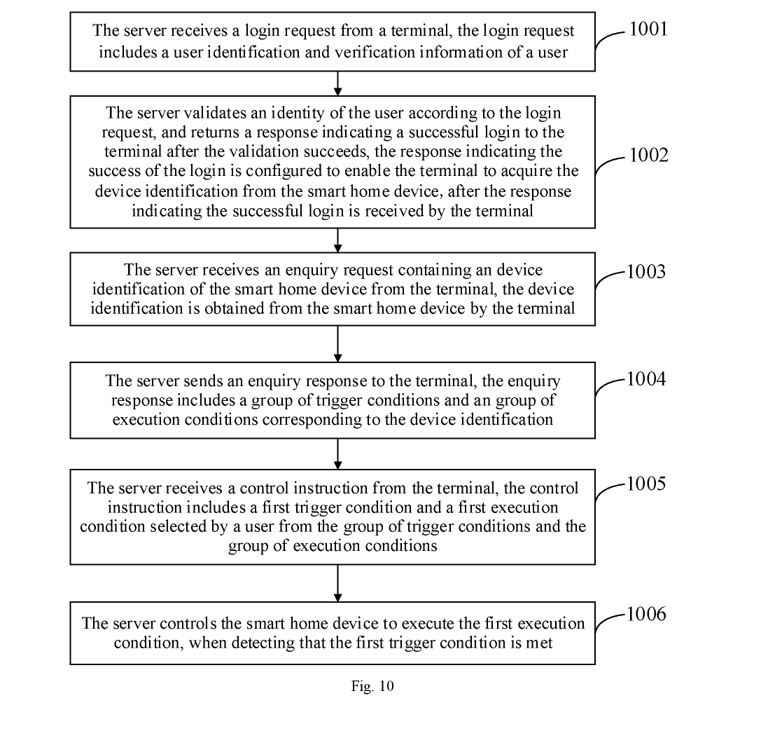

FIG. 10 is a flow chart showing a method for controlling a smart home device, according to another exemplary embodiment. As shown in FIG. 10, this embodiment is exemplified by applying the method for controlling a smart home device in a server. The method for controlling a smart home device may include the following steps.

In step 1001, the server receives a login request from a terminal. The login request includes a user identification and verification information of a user.

In step 1002, the server validates an identity of the user according to the login request, and returns a response indicating a successful login to the terminal upon successful validation. The response indicating the successful login is used to enable the terminal to acquire the device identification from the smart home device upon receiving the response indicating the successful login.

In step 1003, the server receives an enquiry request containing a device identification of the smart home device from the terminal. The device identification is obtained from the smart home device by the terminal.

In step 1004, the server sends an enquiry response to the terminal. The enquiry response includes a group of trigger conditions and a group of execution conditions corresponding to the device identification.

In step 1005, the server receives a control instruction from the terminal. The control instruction includes a first trigger condition and a first execution condition selected by a user from the group of trigger conditions and the group of execution conditions.

In step 1006, the server controls the smart home device to execute the first execution condition, when detecting that the first trigger condition is met.

Take a practical scenario for example. Before acquiring the device identification, the user sends the login request to the server via the terminal. The login request is configured to enable the server to validate the identity of the user according to the login request. Specifically, the login request may include the user identification and the verification information. The user identification may be identical with that of the above embodiments, and the verification information may be a login password set by the user during registration. The server validates the identity of the user according to the login request, and returns the response indicating the successful login to the terminal upon successful validation. After receiving the response indicating the successful login, the terminal acquires the device identification from the smart home device and executes subsequent steps in the method for controlling a smart home device.

It should be noted that, this embodiment may be implemented in combination with any one of the embodiments shown in FIGS. 7-9. Specifically, for example, the server validates the identity of the user according to the login request for validating the identity of the user from the terminal, instructs the terminal to acquire the device identification of the smart home device upon successful validation, and executes subsequent steps of the method for controlling a smart home device.

The method for the terminal involved in this embodiment may refer to related contents in above embodiments, which will not be described herein.

In conclusion, according to the method for controlling a smart home device according to the embodiment of the present disclosure, the terminal sends the login request including the user identification and the verification information to the server, the server validates the identity of the user according to the login request, and after the login succeeds, the terminal executes subsequent steps of the method for controlling a smart home device. By validating the identity of the user before controlling the smart home device, thereby security of smart home is further increased.

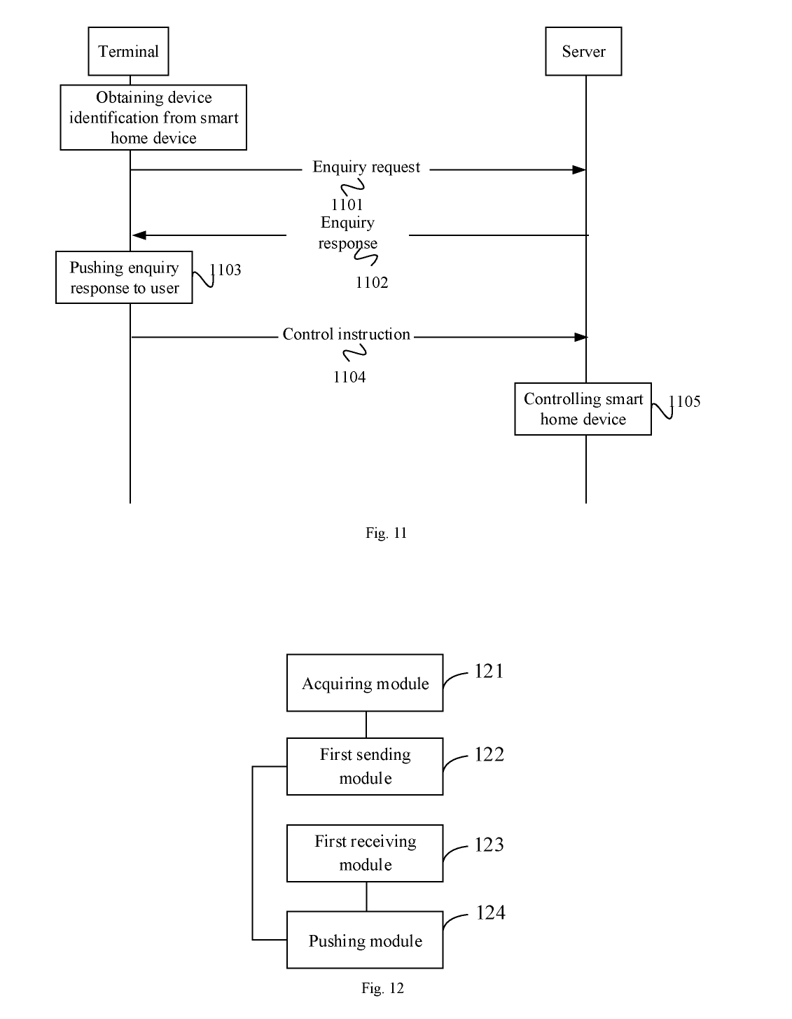

FIG. 11 is a flow chart showing a method for controlling a smart home device, according to an exemplary embodiment. As shown in FIG. 11, this embodiment is exemplified by applying the method for controlling a smart home device in a terminal and a server. The method for controlling a smart home device may include the following steps.

In step 1101, a terminal acquires a device identification of the smart home device from the smart home device, and sends an enquiry request containing the device identification to a server.

In step 1102, the server sends an enquiry response to the terminal. The enquiry response includes a group of trigger conditions and a group of execution conditions corresponding to the device identification.

In step 1103, the terminal pushes the enquiry response to the user.

In step 1104, the terminal sends a control instruction to the server. The control instruction includes a first trigger condition and a first execution condition selected by the user from the group of trigger conditions and the group of execution conditions.

In step 1105, the server controls the smart home device to execute the first execution condition, when detecting that the first trigger condition is met.

The implementation of the method for controlling a smart home device is described above. The method may be implemented via the terminal and the server. Internal functions and structures of the terminal and the server will be illustrated below.

FIG. 12 is a block diagram illustrating a terminal, according to an exemplary embodiment. As shown in FIG. 12, the terminal includes: an acquiring module 121, configured to acquire a device identification of a smart home device from the smart home device; a first sending module 122, configured to send an enquiry request containing the device identification to a server; a first receiving module 123, configured to receive an enquiry response from the server, the enquiry response including a group of trigger conditions and a group of execution conditions corresponding to the device identification; a pushing module 124, configured to push the enquiry response to a user; the first sending module 122, further configured to send a control instruction to the server, the control instruction including a first trigger condition and a first execution condition selected by the user according to the group of trigger conditions and the group of execution conditions, the control instruction configured to enable the server to control the smart home device to execute the first execution condition when the server detects that the first trigger condition is met.

The device identification is used for characterizing the smart home device, for example, the device identification may be an MAC (Media Access Control) address of the smart home device.

Take a practical application scenario for example. The scenario refers to a smart home, which may include a large number of smart home devices.

In this embodiment, the acquiring module 121 acquires the device identification of the smart home device from the smart home device, the first sending module 122 sends the enquiry request containing the device identification to the server, the server searches for a group of trigger conditions and a group of execution conditions supported by the smart home device according to the device identification in the enquiry request, and the server returns an enquiry response including the group of trigger conditions and the group of execution conditions supported by the smart home device to the terminal. After the first receiving module 123 receives the enquiry response, the pushing module 124 pushes the group of trigger conditions and the group of execution conditions supported by the smart home device to the user, the user selects the first trigger condition and the first execution condition required to be configured therefrom. The first sending module 122 includes the first trigger condition and the first execution condition selected by the user into the control instruction and sends the control instruction to the server. According to the control instruction, the server controls the smart home device to execute the first execution condition, thereby implementing smart home, when detecting that the first trigger condition is met.

In practice, in the scenario of a large number of smart home devices, a conventional solution is applied that the user identifies the device identification of the smart home device that the user wants to control from a list of device identifications of a large number of smart home devices, not only has low efficiency, but also easily makes identification error.

However, according to the solution based on the present embodiment, in a scenario of a large number of smart home devices, it is not required for the user to manually identify the device identification of the smart home device that the user wants to control from the list of device identifications of a large number of smart home devices, instead, the user may acquire a corresponding device identification conveniently and accurately from the smart home device that the user wants to control, which improves convenience and reliability of the smart home device control. Moreover, according to the solution of the present embodiment, the groups of trigger conditions and the group of execution conditions supported by various smart home devices may be stored in the server, which further effectively saves a storage resource of the terminal.

In conclusion, the terminal according to the embodiment of the present disclosure obtains the device identification of the smart home device from the smart home device required to be controlled by the user, the terminal obtains the group of trigger conditions and the group of execution conditions supported by the smart home device from the server according to the device identification, the user selects required trigger condition and execution condition from the group of trigger conditions and the group of execution conditions, and sends the required trigger condition and execution condition to the server via the terminal, and the server controls the smart home device according to the trigger condition and execution condition selected by the user. In the scenario of a large number of smart home devices, the user may identify the device identification of the smart home device required to be controlled conveniently and accurately via the terminal, so as to implement a smart home control in a convenient and accurate way.

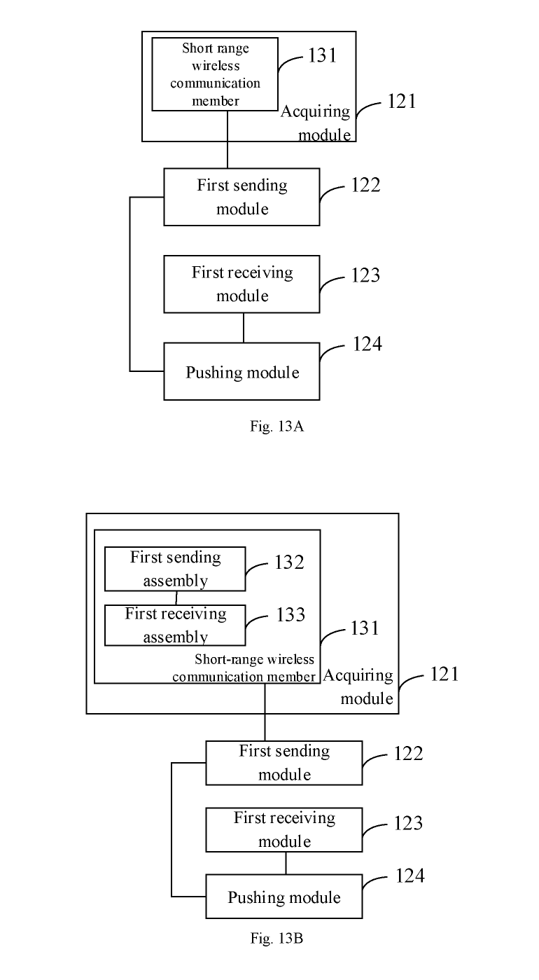

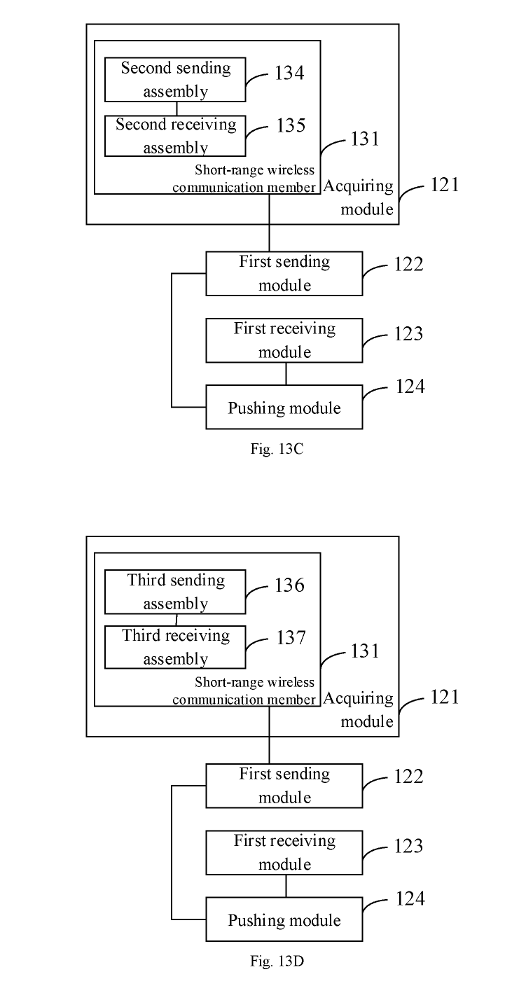

FIG. 13A is a block diagram illustrating a terminal, according to another exemplary embodiment. As shown in FIG. 13A, on the basis of the embodiment shown in FIG. 12, the acquiring module 121 includes: a short-range wireless communication member 131, configured to perform a short-range wireless communication with the smart home device to acquire the device identification.

The short-range wireless communication between the terminal and the smart home device may include many manners.

Alternatively, an NFC may be applied to realize the short-range wireless communication. Accordingly, as shown in FIG. 13B, FIG. 13B is a block diagram illustrating a terminal, according to another exemplary embodiment. Based on the embodiment shown in FIG. 13A, the short-range wireless communication member 131 includes: a first sending assembly 132, configured to send an NFC connection request to the smart home device to establish an NFC connection with the smart home device, further configured to send a first acquiring request to the smart home device via the NFC connection; and a first receiving assembly 133, configured to receive a first acquiring response from the smart home device via the NFC connection, the first acquiring response including the device identification.

In practice, the first sending assembly 132 sends the NFC connection request to an NFC tag of the smart home device. In this way, an NFC connection between the terminal and the smart home device may be established, and thus a data communication therebetween is realized based on the NFC connection. Specifically, the first sending assembly 132 sends the acquiring request to the NFC tag of the smart home device via the NFC connection, and the smart home device sends the device identification stored in itself to the first receiving assembly 133 via the NFC tag according to the acquiring request, thus enabling the terminal to acquire the device identification of the smart home device in a convenient and accurate way.

Still further alternatively, an RFID (Radio Frequency Identification) may be applied to realize the short-range wireless communication. Accordingly, as shown in FIG. 13C, FIG. 13C is a block diagram illustrating a terminal, according to another exemplary embodiment. On the basis of the embodiment shown in FIG. 13A, the short-range wireless communication member 131 includes: a second sending assembly 134 configured to send an RF signal to an RFID tag of the smart home device, wherein the RFID tag stores the device identification of the smart home device; and a second receiving assembly 135 configured to receive the device identification from the RFID tag by the RF signal.

In practice, the second sending assembly 134 sends the RF signal to the RFID tag of the smart home device, the RFID tag of the smart home device sends the device identification stored in itself to the second receiving assembly 135 in response to the RF signal, thereby enabling the terminal to acquire the device identification of the smart home device in a convenient and accurate way.

Still further alternatively, a Bluetooth may be applied to realize the short-range wireless communication. Accordingly, as shown in FIG. 13D, FIG. 13D is a block diagram illustrating a terminal, according to another exemplary embodiment. On the bases of the embodiment shown in FIG. 13A, the short-range wireless communication member 131 includes: a third sending assembly 136 configured to send a pairing request to the smart home device and establish a Bluetooth connection with the smart home device according to a pairing response from the smart home device, further configured to send a second acquiring request to the smart home device via the Bluetooth connection; and a third receiving assembly 137, configured to receive a second acquiring response from the smart home device via the Bluetooth connection, the second acquiring response including the device identification.

In practice, the third sending assembly 136 sends the pairing request to the smart home device. In this way, a Bluetooth connection between the terminal and the smart home device may be established according to the pairing response from the smart home device, and thus a data communication therebetween is realized based on the Bluetooth connection. Specifically, the third sending assembly 136 sends the acquiring request to the smart home device via the Bluetooth connection, and the smart home device sends the device identification stored in itself to the third receiving assembly 137 via the Bluetooth connection according to the acquiring request, thereby enabling the terminal to acquire the device identification of the smart home device in a convenient and accurate way.

In conclusion, the terminal according to the embodiment of the present disclosure, by using the short-range wireless communication manner, obtains the device identification of the smart home device that the user wants to control. In other words, the user may obtain the device identification of the smart home device smart home device only by staying around the smart home device, which achieves controlling of the smart home device in a convenient and accurate way.

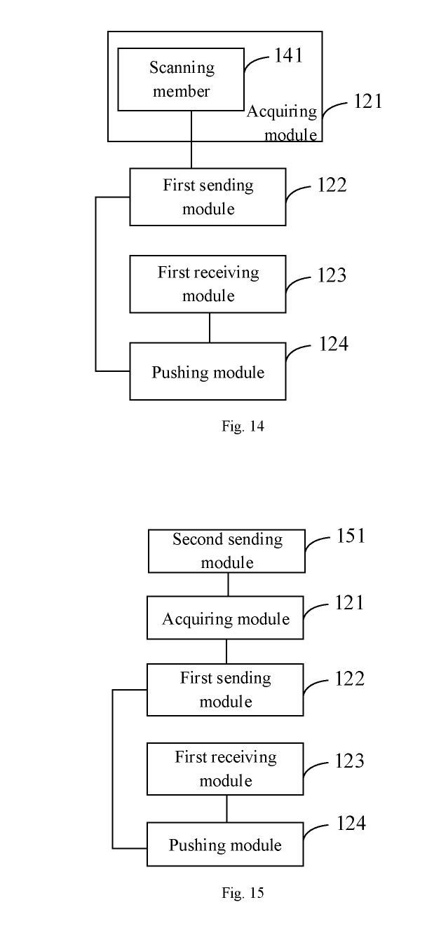

FIG. 14 is a block diagram illustrating a terminal, according to another exemplary embodiment. As shown in FIG. 14, on the basis of the embodiment shown in FIG. 12, the acquiring module 121 includes: a scanning member 141 configured to acquire the device identification by scanning a two-dimension code of the smart home device.

In practice, the device identification of the smart home device may be encoded into the two-dimension code, and the two-dimension code is disposed on the smart home device. Accordingly, the user may simply use the scanning member 141 of the terminal to scan the two-dimension code of the smart home device to read the device identification of the smart home device.

In conclusion, the terminal according to the embodiment of the present disclosure, by scanning the two-dimension code of the smart home device, obtains the device identification of the smart home device, thereby implementing a control for the smart home device in a convenient and accurate way.

FIG. 15 is a block diagram illustrating a terminal, according to another exemplary embodiment. As shown in FIG. 15, on the basis of any one of embodiments shown in FIGS. 12-14, the enquiry request further includes a user identification of the user, and the enquiry response is transmitted by the server after the server detects that the user identification and the device identification have a binding relationship according to device identifications currently bound to respective user identifications. The terminal further includes: a second sending module 151 configured to send a binding request to the server. The binding request includes the user identification, the device identification and verification information, and the binding request is configured to enable the server to establish the binding relationship between the user identification and the device identification, after successful validation of the verification information by the server.

The user identification refers to an identification characterizing an identity of the user. Specifically, the terminal may directly acquire a pre-stored user identification, or may receive the user identification inputted by the user via an interactive interface.

In practice, the verification information is used for validating the ownership between the user and the smart home device. Take a practical scenario for example. After the first acquiring module 121 acquires the device identification of the smart home device from the smart home device, the first sending module 122 sends an enquiry request containing the device identification and the user identification to the server. The server inquires device identifications currently bound to respective user identifications according to the enquiry request received. The binding relationship between the user identification and the device identification mentioned herein is for proving an ownership relation between the smart home device and the user. When determining that the device identification belongs to one of device identifications currently bound to the user identification, the server returns the enquiry response to the terminal.

In conclusion, the terminal according to the embodiment of the present disclosure sends the binding request including the user identification, the verification information and the device identification to the server, and the server validates the ownership between the smart home device and the user according to the verification information in the binding request, and the binding relationship between the user and the smart home device is established upon successful validation. After receiving the enquiry request from the terminal and determining that the smart home device to be controlled belongs to the user base on the binding relationship between respective user identifications and respective device identifications, the server then executes subsequent schemes of smart home device controlling, thereby improving the security of smart home.

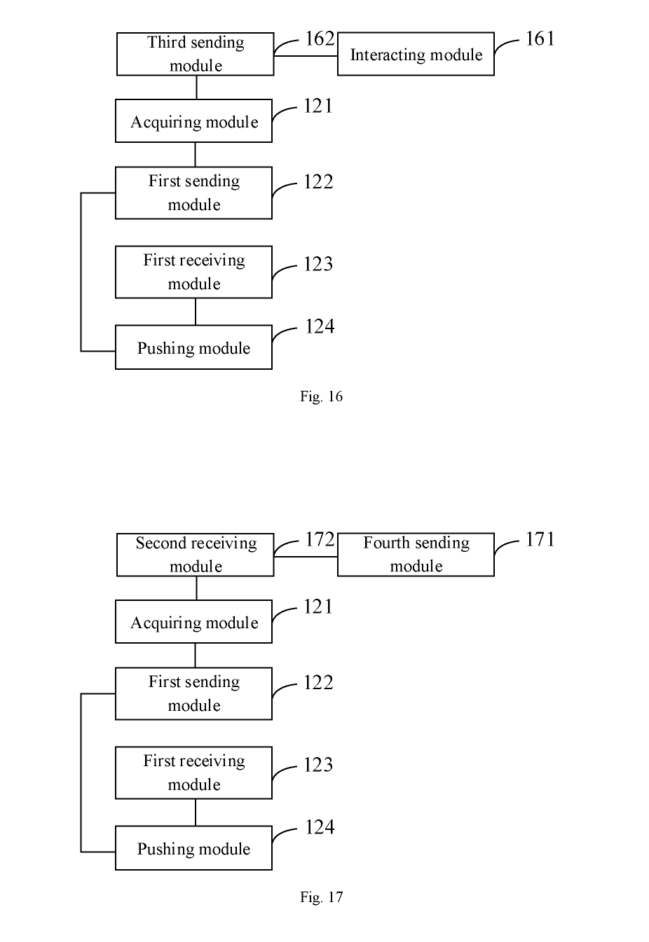

FIG. 16 is a block diagram illustrating a terminal according to another exemplary embodiment. As shown in FIG. 16, on the basis of any one of embodiments shown in FIGS. 12-15, the terminal further includes: an interacting module 161 configured to receive a second trigger condition inputted by the user after the acquiring module obtains the device identification of the smart home device from the smart home device; and a third sending module 162 configured to send a configuration instruction to the server according to the second trigger condition, the configuration instruction including the device identification and the second trigger condition, and the configuration instruction configured to enable the server to add the second trigger condition into the group of trigger conditions corresponding to the device identification.

Take a practical scenario as an example. If the user needs to set the trigger condition of certain smart home device, the user may use the terminal to acquire the device identification of the smart home device from the smart home device, and then input the second trigger condition via the interacting module 161. The third sending module 162 sends the configuration instruction including the device identification and the second trigger condition set by the user to the server. Then the server adds the second trigger condition set by the user into the group of trigger conditions supported by the smart home device according to the configuration instruction.

In conclusion, the terminal according to the embodiment of the present disclosure sends the configuration instruction including the device identification of the smart home device and the second trigger condition set by the user to the server, and the server adds the second trigger condition set by the user into the group of trigger conditions supported by the smart home device according to the configuration instruction, thereby configuring the group of trigger conditions supported by the smart home device according to user's requirement, and realizing personalization and flexibility of smart home.

FIG. 17 is a block diagram illustrating a terminal, according to another exemplary embodiment. As shown in FIG. 17, on the basis of any one of embodiments shown in FIGS. 12-16, the terminal further includes: a fourth sending module 171 configured to send a login request to the server, the login request including a user identification and verification information of the user, and the login request being used to enable the server to validate an identity of the user according to the login request; and a second receiving module 172 configured to receive a response indicating a successful a login from the server. The acquiring module 121 is configured to acquire the device identification from the smart home device, after the response indicating the success of the login is received by the second receiving module 172.

Take a practical scenario as an example. Before acquiring the device identification, the fourth sending module 171 sends the login request to the server. The login request is configured to enable the server to validate the identity of the user according to the login request. The server validates the identity of the user according to the login request, and returns the response indicating a successful login to the terminal after the validation succeeds. After the second receiving module 172 receives the response indicating the successful login, the acquiring module 121 acquires the device identification from the smart home device and executes subsequent steps in the method for controlling a smart home device.

In conclusion, the terminal according to the embodiment of the present disclosure sends the login request including the user identification and the verification information to the server, the server validates the identity of the user according to the login request, and after the login succeeds, the terminal executes corresponding steps in the method for controlling a smart home device. By validating the identity of the user before controlling the smart home device, security of smart home is further increased.

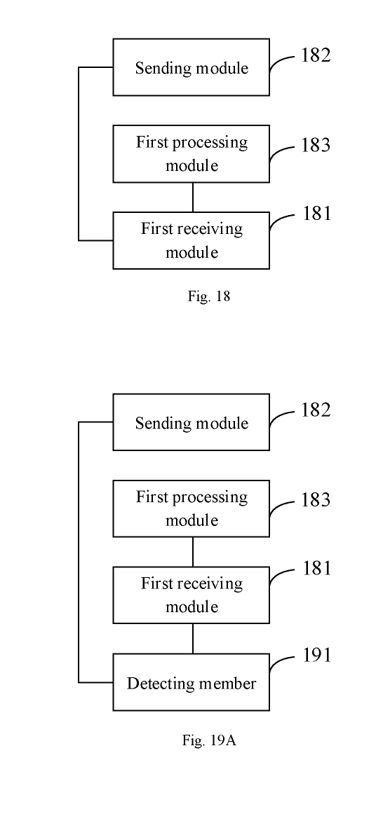

FIG. 18 is a block diagram illustrating a server, according to an exemplary embodiment. As shown in FIG. 18, the server includes: a first receiving module 181 configured to receive an enquiry request containing a device identification of a smart home device sent from a terminal, the device identification being obtained from the smart home device by the terminal; a sending module 182 configured to send an enquiry response to the terminal, the enquiry response including a group of trigger conditions and a group of execution conditions corresponding to the device identification; and a first processing module 183; in which the first receiving module 181 is further configured to receive a control instruction from the terminal, the control instruction including a first trigger condition and a first execution condition selected by a user from the group of trigger conditions and the group of execution conditions; and the first processing module 183 is configured to control the smart home device to execute the first execution condition when detecting that the first trigger condition is met.

The device identification is used for characterizing the smart home device, for example, the device identification may be an MAC (Media Access Control) address of the smart home device.

Based on the solution of the present embodiment, in a scenario of a large number of smart home devices, it is not required for the user to manually identify the device identification of the smart home device that the user wants to control from the list of device identifications of a large number of smart home devices, instead, the user may acquire a corresponding device identification conveniently and accurately from the smart home device that the user wants to control, which improves convenience and reliability of the smart home device control. Moreover, according to the solution of the present embodiment, the groups of trigger conditions and the group of execution conditions supported by various smart home devices may be stored in the server, thus further effectively saves a storage resource of the terminal.

The terminal may acquire the device identification from the smart home device via various manners, which may refer to the embodiments above.

In conclusion, the server according to the embodiment of the present disclosure receives the device identification obtained by the terminal from the smart home device to be controlled, and returns the group of trigger conditions and the group of execution conditions supported by the smart home device to the terminal, the user selects required trigger condition and execution condition from the group of trigger conditions and the group of execution conditions, and sends the required trigger condition and execution condition to the server via the terminal, and the server controls the smart home device according to the trigger condition and execution condition selected by the user. In the scene of a large number of smart home devices, the user may identify the device identification of the smart home device required to be controlled conveniently and accurately via the terminal, so as to implement a smart home control in a convenient and accurate way.

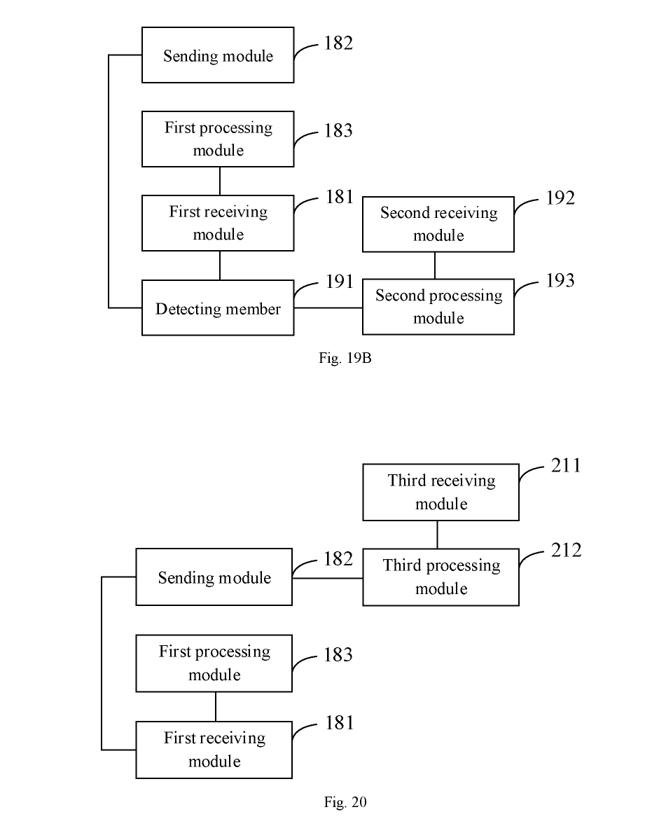

FIG. 19A is a block diagram illustrating a server according to another exemplary embodiment. As shown in FIG. 19A, on the basis of the embodiment shown in FIG. 18, the enquiry request further includes a user identification of the user; the server further includes: a detecting member 191 configured to detect whether the user identification and the device identification have a binding relationship according to a device identification currently bound to respective user identification; a sending module 182 configured to send the enquiry response to the terminal when the detecting member detects that the user identification and the device identification have the binding relationship.

The user identification refers to an identification characterizing an identity of the user.

Take a practical scenario as an example. After acquiring the device identification of the smart home device from the smart home device, the terminal sends an enquiry request containing the device identification and the user identification to the server. The detecting member 191 inquires device identifications currently bound to respective user identifications according to the enquiry request received by the first receiving module 181. The binding relationship between the user identification and the device identification mentioned herein is used for characterizing an ownership between the smart home device and the user. After the detecting member 191 determines that the device identification belongs to one of device identifications currently bound to the user identification, the sending module 182 returns the enquiry response to the terminal.

In order to establish the binding relationship between respective user identification and respective device identification, FIG. 19B illustrates a block diagram of a server according to another exemplary embodiment. On the basis of the embodiment shown in FIG. 19A, the server further includes: a second receiving module 192 configured to receive a binding request from the terminal, the binding request including the user identification, the device identification and verification information; and a second processing module 193 configured to validate the verification information, and establish the binding relationship between the user identification and the device identification after the verification information is successfully validated.

In practice, the verification information is used for validating the ownership between the user and the smart home device.

In conclusion, the server according to the embodiment of the present disclosure validates the ownership between the smart home device and the user according to the verification information in the binding request, and establishes the binding relationship between the user and the smart home device after successful validation. Subsequently, when receiving the enquiry request from the terminal, the server first determines that the smart home device to be controlled belongs to the user according to the binding relationship between respective user identification and respective device identification, and then executes following smart home device control solution, which improves security of smart home.

FIG. 20 is a block diagram illustrating a server according to another exemplary embodiment. As shown in FIG. 20, on the basis of the embodiments shown in FIG. 18, FIG. 19A or FIG. 19B, the server further includes: a third receiving module 211 configured to receive a configuration instruction from the terminal, wherein the configuration instruction is sent by the terminal according to a second trigger condition inputted by the user, and wherein the configuration instruction includes the device identification and the second trigger condition; and a third processing module 212 configured to add the second trigger condition into the group of trigger conditions corresponding to the device identification.

Take a practical scenario as an example. When a user needs to set trigger condition for certain smart home device, the user may use the terminal to acquire the device identification of the smart home device from the smart home device, and input the second trigger condition via an interactive interface of the terminal. The third receiving module 211 receives the configuration instruction sent by the terminal, the configuration instruction including the device identification and the second trigger condition set by the user, the third processing module 212 adds the second trigger condition set by the user into the group of trigger conditions supported by the smart home device.

In conclusion, according to the method for controlling a smart home device according to the embodiment, the terminal sends the configuration instruction including the device identification and the second trigger condition set by the user to the server, and the server adds the second trigger condition set by the user into the group of trigger conditions supported by the smart home device according to the configuration instruction, thereby configuring the group of trigger conditions supported by the smart home device according to user requirement, and realizing personalization and flexibility of smart home.

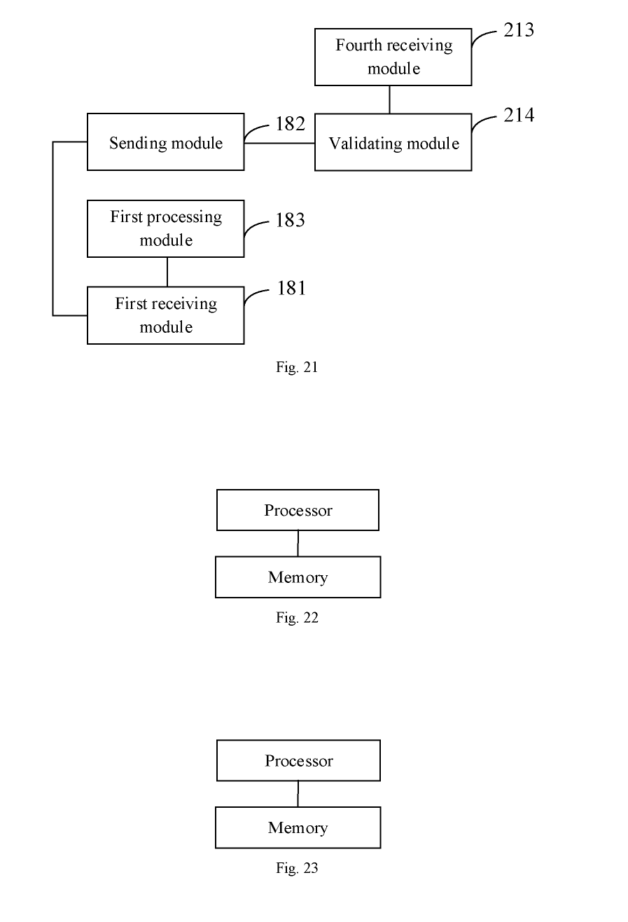

FIG. 21 is a block diagram illustrating a server, according to another exemplary embodiment. As shown in FIG. 21, on the basis of any one of the embodiments shown in FIGS. 18-20, the server further includes: a fourth receiving module 213 configured to receive a login request from the terminal before the first receiving module 181 receives an enquiry request containing a device identification of the smart home device from the terminal, the login request including a user identification and verification information of the user; and a validating module 214 configured to validate an identity of the user according to the login request. The sending module 182 is further configured to return a response indicating a successful login to the terminal after the validation performed by the validating module 214 succeeds, the response indicating the successful login configured to enable the terminal to acquire the device identification from the smart home device upon receiving the response indicating the successful login.

Take a practical scenario as an example. The fourth receiving module 213 receives the login request from the terminal, the validating module 214 validates the identity of the user according to the login request, and the sending module 182 returns the response indicating the successful login to the terminal after a successful validation. After receiving the response indicating the successful login, the terminal acquires the device identification from the smart home device and executes subsequent steps in the method for controlling a smart home device.

In conclusion, the server according to the embodiment of the present disclosure validates the identity of the user according to the login request sent by the terminal, wherein the login request includes the user identification and the verification information, and after a successful validation, the server executes corresponding steps in the method for controlling a smart home device. By validating the identity of the user before controlling the smart home device, security of smart home is further increased.

FIG. 22 is a block diagram of a terminal, according to an exemplary embodiment. As shown in FIG. 22, the terminal may be implemented to include: a processor; and a memory for storing instructions executable by the processor. The processor is configured to perform: acquiring a device identification of the smart home device from the smart home device, and sending an enquiry request containing the device identification to a server; receiving an enquiry response from the server and pushing the enquiry response to a user, the enquiry response including a group of trigger conditions and a group of execution conditions corresponding to the device identification; sending a control instruction to the server, the control instruction including a first trigger condition and a first execution condition selected by the user from the group of trigger conditions and the group of execution conditions, the control instruction being configured to enable the server to control the smart home device to execute the first execution condition when the server detects that the first trigger condition is met.

The terminal according to the embodiments of the present disclosure obtains the device identification of the smart home device from the smart home device required to be controlled by the user, and obtains the group of trigger conditions and the group of execution conditions supported by the smart home device from the server according to the device identification, the user selects required trigger condition and execution condition from the group of trigger conditions and the group of execution conditions, and sends the required trigger condition and execution condition to the server via the terminal, and the server controls the smart home device according to the trigger condition and execution condition selected by the user. In the scenario of a large number of smart home devices, the user may identify the device identification of the smart home device required to be controlled conveniently and accurately via the terminal, so as to implement a smart home control in a convenient and accurate way.

FIG. 23 is a block diagram of a server, according to an exemplary embodiment. As shown in FIG. 23, the server may be implemented to include: a processor; and a memory for storing instructions executable by the processor. The processor is configured to perform: receiving an enquiry request containing a device identification of the smart home device from a terminal, the device identification obtained from the smart home device by the terminal; sending an enquiry response to the terminal, the enquiry response including a group of trigger conditions and a group of execution conditions corresponding to the device identification; receiving a control instruction from the terminal, the control instruction including a first trigger condition and a first execution condition selected by a user according to the group of trigger conditions and the group of execution conditions; controlling the smart home device to execute the first execution condition, when detecting that the first trigger condition is met.

The server according to the embodiments of the present disclosure receives the device identification obtained by the terminal from the smart home device required to be controlled and returns the group of trigger conditions and the group of execution conditions supported by the smart home device to the terminal. The user selects required trigger condition and execution condition from the group of trigger conditions and the group of execution conditions, and sends the required trigger condition and execution condition to the server via the terminal. Then the server controls the smart home device according to the trigger condition and execution condition selected by the user. In the scenario of a large number of smart home devices, the user may identify the device identification of the smart home device required to be controlled conveniently and accurately via the terminal, so as to implement a smart home control in a convenient and accurate way.

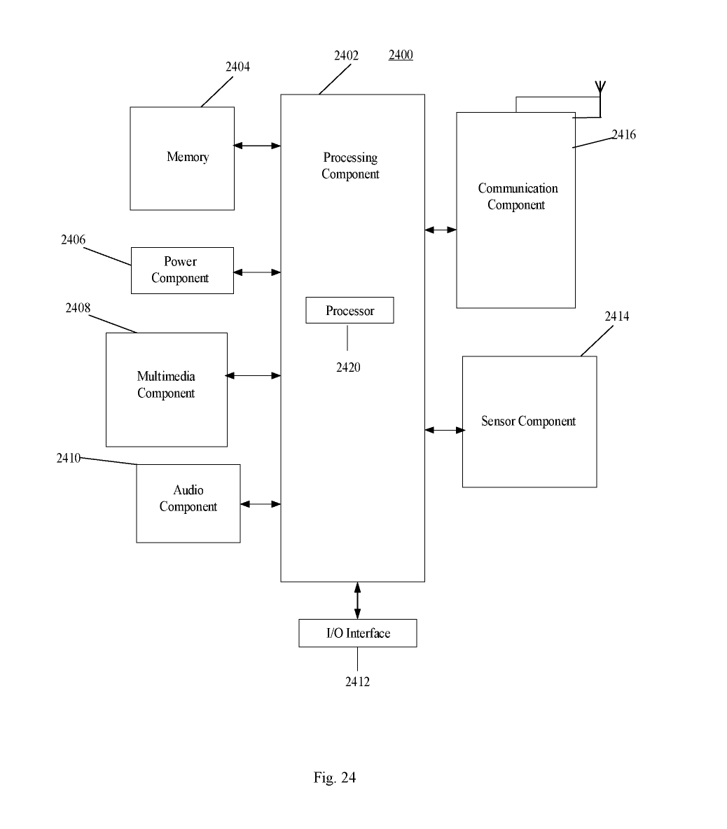

FIG. 24 is a block diagram of a terminal 2400 according to an exemplary embodiment. For example, the terminal 2400 may be a mobile phone, a computer, a digital broadcast terminal, a messaging device, a gaming console, a tablet, a medical device, exercise equipment, a personal digital assistant, and the like.

Referring to FIG. 24, the terminal 2400 may include one or more of the following components: a processing component 2402, a memory 2404, a power component 2406, a multimedia component 2408, an audio component 2410, an input/output (I/O) interface 2412, a sensor component 2414, and a communication component 2416.

The processing component 2402 typically controls overall operations of the terminal 2400, such as the operations associated with display, telephone calls, data communications, camera operations, and recording operations. The processing component 2402 may include one or more processors 2420 to execute instructions to perform all or part of the steps in the above described methods. Moreover, the processing component 2402 may include one or more modules which facilitate the interaction between the processing component 2402 and other components. For instance, the processing component 2402 may include a multimedia module to facilitate the interaction between the multimedia component 2408 and the processing component 2402.

The memory 2404 is configured to store various types of data to support the operation of the terminal 2400. Examples of such data include instructions for any applications or methods operated on the terminal 2400, contact data, phonebook data, messages, pictures, video, etc. The memory 2404 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 2406 provides power to various components of the terminal 2400. The power component 2406 may include a power management system, one or more power sources, and any other components associated with the generation, management, and distribution of power in the terminal 2400.

The multimedia component 2408 includes a screen providing an output interface between the terminal 2400 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 2408 includes a front camera and/or a rear camera. The front camera and the rear camera may receive an external multimedia datum while the terminal 2400 is in an operation mode, such as a photographing mode or a video mode. Each of the front camera and the rear camera may be a fixed optical lens system or have focus and optical zoom capability.

The audio component 2410 is configured to output and/or input audio signals. For example, the audio component 2410 includes a microphone (“MIC”) configured to receive an external audio signal when the terminal 2400 is in an operation mode, such as a call mode, a recording mode, and a voice recognition mode. The received audio signal may be further stored in the memory 2404 or transmitted via the communication component 2416. In some embodiments, the audio component 2410 further includes a speaker to output audio signals.

The I/O interface 2412 provides an interface between the processing component 2402 and peripheral interface modules, such as a keyboard, a click wheel, buttons, and the like. The buttons may include, but are not limited to, a home button, a volume button, a starting button, and a locking button.

The sensor component 2414 includes one or more sensors to provide status assessments of various aspects of the terminal 2400. For instance, the sensor component 2414 may detect an open/closed status of the terminal 2400, relative positioning of components, e.g., the display and the keypad, of the terminal 2400, a change in position of the terminal 2400 or a component of the terminal 2400, a presence or absence of user contact with the terminal 2400, an orientation or an acceleration/deceleration of the terminal 2400, and a change in temperature of the terminal 2400. The sensor component 2414 may include a proximity sensor configured to detect the presence of nearby objects without any physical contact. The sensor component 2414 may also include a light sensor, such as a CMOS or CCD image sensor, for use in imaging applications. In some embodiments, the sensor component 2414 may also include an accelerometer sensor, a gyroscope sensor, a magnetic sensor, a pressure sensor, or a temperature sensor.

The communication component 2416 is configured to facilitate communication, wired or wirelessly, between the terminal 2400 and other devices. The terminal 2400 can access a wireless network based on a communication standard, such as WiFi, 2G, or 3G, or a combination thereof. In one exemplary embodiment, the communication component 2416 receives a broadcast signal or broadcast associated information from an external broadcast management system via a broadcast channel. In one exemplary embodiment, the communication component 2416 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the terminal 2400 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 2404, executable by the processor 2420 in the terminal 2400, for performing the above-described methods. For example, the non-transitory computer-readable storage medium may be a ROM, a RAM, a CD-ROM, a magnetic tape, a floppy disc, an optical data storage device, and the like.

A non-transitory computer-readable storage medium having stored therein instructions that, when executed by a processor of a mobile terminal, causes the mobile terminal to perform a method for controlling a smart home device. The method includes: acquiring a device identification of a smart home device from the smart home device, and sending an enquiry request containing the device identification to a server; receiving an enquiry response from the server and pushing the enquiry response to a user, the enquiry response including a group of trigger conditions and a group of execution conditions corresponding to the device identification; sending a control instruction to the server, the control instruction including a first trigger condition and a first execution condition selected by the user from the group of trigger conditions and the group of execution conditions, the control instruction configured to enable the server to control the smart home device to execute the first execution condition when the server detects that the first trigger condition is met.

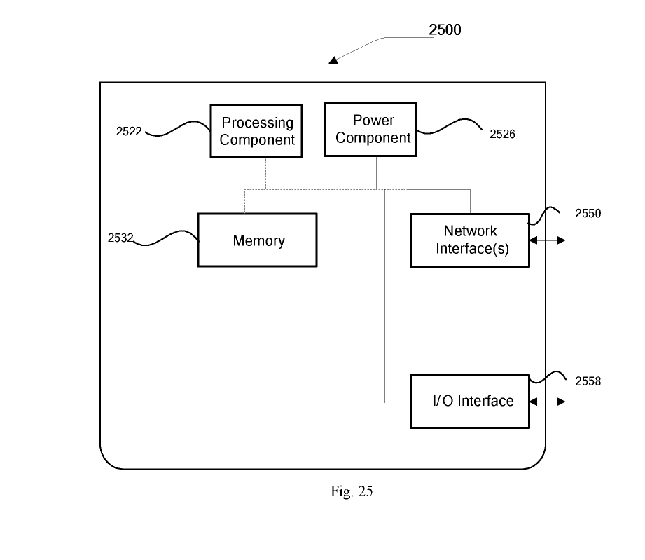

FIG. 25 is a block diagram of a server 2500, according to an exemplary embodiment. For example, the server 2500 may be a server. Referring to FIG. 25, the server 2500 includes a processing component 2522 (e.g. one or more processors), a memory source represented by a memory 2532 for storing instructions (e.g. application programs) executed by the processing component 2522. The application programs stored in the memory 2532 may include one or more modules (not shown). Each module may include a set of instructions. Further, the processing component 2522 may be configured to execute the sets of instructions to execute the method described above: receiving an enquiry request containing a device identification of the smart home device from a terminal, the device identification obtained from the smart home device by the terminal; sending an enquiry response to the terminal, the enquiry response including a group of trigger conditions and a group of execution conditions corresponding to the device identification; receiving a control instruction from the terminal, the control instruction including a first trigger condition and a first execution condition selected by a user according to the group of trigger conditions and the group of execution conditions; controlling the smart home device to execute the first execution condition, when detecting that the first trigger condition is met.

The server 2500 may also include a power supply 2526 configured to perform a power management of the server 2500, a wired or wireless network interfaces 2550 configured to connection the server 2500 to the network, an input/output interfaces 2558. The server 2500 may operate an operating systems (such as Windows Server™, Mac OS X™, Unix™, Linux™, FreeBSD™, or the like) stored in the memory 2532.

It may be clearly understood by those skilled in the art that, for purpose of convenience and simple for description, the specific operating processes of the terminal and the server described above may refer to corresponding processes in the method embodiments described above.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method implemented in a terminal for controlling a smart home device, comprising:
acquiring a device identification of the smart home device from the smart home device, and sending an enquiry request containing the device identification to a server;
receiving an enquiry response from the server and pushing the enquiry response to a user, the enquiry response comprising a group of trigger conditions and a group of execution conditions corresponding to the device identification; and
sending a control instruction to the server, the control instruction comprising a first trigger condition and a first execution condition selected by the user from the group of trigger conditions and the group of execution conditions, the control instruction being configured to enable the server to control the smart home device to execute the first execution condition when the server detects that the first trigger condition is met.

2. The method of claim 1, wherein acquiring the device identification of the smart home device from the smart home device comprises:
acquiring the device identification via a short-range wireless communication with the smart home device.

3. The method of claim 2, wherein acquiring the device identification via the short-range wireless communication with the smart home device comprises:
sending an NFC (Near Field Communication) connection request to the smart home device to establish an NFC connection with the smart home device;
sending a first acquiring request to the smart home device via the NFC connection; and
receiving a first acquiring response from the smart home device via the NFC connection, the first acquiring response comprising the device identification.

4. The method of claim 2, wherein acquiring the device identification via the short-range wireless communication with the smart home device comprises:
sending an RF (Radio Frequency) signal to an RFID (Radio Frequency Identification) tag of the smart home device, wherein the device identification of the smart home device is stored in the RFID tag; and
receiving the device identification from the RFID tag according to the RF signal.

5. The method of claim 2, wherein acquiring the device identification via the short-range wireless communication with the smart home device comprises:
sending a pairing request to the smart home device and establishing a Bluetooth connection with the smart home device according to a pairing response from the smart home device;
sending a second acquiring request to the smart home device via the Bluetooth connection; and
receiving a second acquiring response from the smart home device via the Bluetooth connection, the second acquiring response comprising the device identification.

6. The method of claim 1, wherein acquiring the device identification of the smart home device from the smart home device comprises:
acquiring the device identification by scanning a two-dimension code of the smart home device.

7. The method of claim 1, wherein the enquiry request further comprises a user identification, and the enquiry response is transmitted by the server after the server detects that the user identification and the device identification have a binding relationship according to a device identification currently bound to respective user identification.

8. The method of claim 7, further comprising:
sending a binding request to the server, the binding request comprising the user identification, the device identification and verification information, the binding request being configured to enable the server to establish the binding relationship between the user identification and the device identification after the verification information is successfully validated by the server.

9. The method of claim 1, after acquiring the device identification of the smart home device from the smart home device, further comprising:
sending a configuration instruction to the server according to a second trigger condition inputted by the user, the configuration instruction comprising the device identification and the second trigger condition, and the configuration instruction being configured to enable the server to add the second trigger condition into the group of trigger conditions corresponding to the device identification.

10. The method of claim 1, after acquiring the device identification of the smart home device from the smart home device, further comprising:
sending a login request to the server, the login request comprising a user identification and verification information of the user, and the login request configured to enable the server to validate an identity of the user according to the login request; and
acquiring the device identification from the smart home device by the server, after receiving a response indicating a successful login from the server.

11. A method implemented in a server for controlling a smart home device, the method comprising:
receiving an enquiry request containing a device identification of the smart home device from a terminal, the device identification obtained from the smart home device by the terminal;
sending an enquiry response to the terminal, the enquiry response comprising a group of trigger conditions and a group of execution conditions corresponding to the device identification;
receiving a control instruction from the terminal, the control instruction comprising a first trigger condition and a first execution condition selected by a user from the group of trigger conditions and the group of execution conditions; and
controlling the smart home device to execute the first execution condition by the server, when detecting that the first trigger condition is met.

12. The method of claim 11, wherein the enquiry request further comprises the user identification of the user; and
sending an enquiry response to the terminal comprises:
sending the enquiry response to the terminal after detecting that the user identification and the device identification have a binding relationship according to a device identification currently bound to respective user identification.

13. The method of claim 12, further comprising:
receiving a binding request from the terminal, the binding request comprising the user identification, the device identification and verification information; and
establishing the binding relationship between the user identification and the device identification, after successfully validating the verification information.

14. The method of claim 11, further comprising:
receiving a configuration instruction from the terminal, wherein the configuration instruction is sent by the terminal according to a second trigger condition inputted by the user, and the configuration instruction comprises the device identification and the second trigger condition; and
adding the second trigger condition into the group of trigger conditions corresponding to the device identification.

15. The method of claim 11, before receiving an enquiry request containing a device identification of the smart home device from a terminal, further comprising:
receiving a login request from the terminal, the login request comprising a user identification and verification information of the user; and
validating an identity of the user according to the login request, and returning a response indicating a successful login to the terminal after successful validation of the identity of the user, the response indicating the success login being configured to enable the terminal to acquire the device identification from the smart home device after the response indicating the successful login is received by the terminal.

16. A terminal, comprising:
a processor; and
a memory for storing instructions executable by the processor;
wherein the processor is configured to perform: acquiring a device identification of the smart home device from the smart home device, and sending an enquiry request containing the device identification to a server; receiving an enquiry response from the server and pushing the enquiry response to a user, the enquiry response comprising a group of trigger conditions and a group of execution conditions corresponding to the device identification; sending a control instruction to the server, the control instruction comprising a first trigger condition and a first execution condition selected by the user from the group of trigger conditions and the group of execution conditions, the control instruction being configured to enable the server to control the smart home device to execute the first execution condition when the server detects that the first trigger condition is met.

17. The terminal of claim 16, wherein the enquiry request further comprises a user identification of the user, and the enquiry response is transmitted by the server after the server detects that the user identification and the device identification have a binding relationship according to a device identification currently bound to respective user identification.

18. The terminal of claim 17, wherein the processor is further configured to perform:
sending a binding request to the server, wherein the binding request comprises the user identification, the device identification and verification information, and wherein the binding request is configured to enable the server to establish the binding relationship between the user identification and the device identification after successful validation of the verification information by the server.

19. The terminal of claim 16, wherein the processor is further configured to perform:
receiving a second trigger condition inputted by the user, after the device identification of the smart home device is acquired from the smart home device; and
sending a configuration instruction to the server according to the second trigger condition, the configuration instruction comprising the device identification and the second trigger condition, and the configuration instruction being configured to enable the server to add the second trigger condition into the group of trigger conditions corresponding to the device identification.

20. The terminal of claim 16, wherein the processor is further configured to perform:
sending a login request to the server, the login request comprising a user identification and verification information of the user, and the login request being configured to enable the server to validate an identity of the user according to the login request;
receiving a response indicating a successful login from the server; and
acquiring the device identification from the smart home device after the response indicating the successful login is received.
